(19) United States
(12) Patent Application Publication
(10) Pub. No.: US 2025/0193092 A1
(43) Pub. Date: Jun. 12, 2025

(54) ARTIFICIAL-INTELLIGENCE-INFERRED QUALITY OF EXPERIENCE, QUALITY OF SERVICE, AND MINIMIZATION OF DRIVE TEST DATA

(71) Applicant: ZTE Corporation, Shenzhen (CN)

(72) Inventors: Yansheng LIU, Shenzhen (CN); Yin GAO, Shenzhen (CN); Dapeng LI, Shenzhen (CN); Man ZHANG, Shenzhen (CN); Zhuang LIU, Shenzhen (CN); Jiajun CHEN, Shenzhen (CN)

(21) Appl. No.: 19/054,588

(22) Filed: Feb. 14, 2025

Related U.S. Application Data
(63) Continuation of application No. PCT/CN2023/089283, filed on Apr. 19, 2023.

(51) Int. Cl. H04L 41/16; H04L 41/082; H04L 41/14; H04L 41/5067

(52) U.S. Cl. CPC H04L 41/16; H04L 41/082; H04L 41/145; H04L 41/5067

(57) ABSTRACT

Systems, methods, and apparatus for wireless communications are described. A wireless communication method includes transmitting, by a network node, a request for input data. The method further includes receiving, by the network node and in response to the request, input data. The described techniques may be adopted by a network device or by a wireless device.

### CROSS-REFERENCE TO RELATED APPLICATION

This application is a continuation and claims priority to International Application No. PCT/CN2023/089283, filed on Apr. 19, 2023, the disclosure of which is hereby incorporated by reference herein in its entirety.

### TECHNICAL FIELD

This patent document is directed generally to wireless communications.

### BACKGROUND

Mobile telecommunication technologies are moving the world toward an increasingly connected and networked society. In comparison with the existing wireless networks, next-generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data rates, large number of connections, ultra-low latency, high reliability, and other emerging business needs.

### SUMMARY

Techniques are disclosed for training artificial intelligence (AI) functions used in wireless communications. This patent document describes the data requests and the input data used to train the AI functions in detail. Techniques are further disclosed for using the AI functions to infer data. This patent document describes the inferred data in detail. This patent document also describes feedback requests and feedback responses in detail.

A first example wireless communication method includes transmitting, by a network node, a request for input data. The method further includes receiving, by the network node and in response to the request, input data.

A second example wireless communication method includes providing, by a network node and using input data, training of an artificial intelligence (AI) function. The method further includes transmitting, by the network node and based on the training, an updated AI function.

A third example wireless communication method includes determining, by a network node and based on input data, inference data using an artificial intelligence (AI) function.

A fourth example wireless communication method includes transmitting, by a network node, inference data. The method further includes transmitting, by the network node, a request for feedback associated with the inference data. The method further includes receiving, by the network node and in response to the request, a feedback response.

A fifth example wireless communication method includes receiving, by a network node, a request for input data. The method further includes transmitting, by the network node and in response to the request, input data.

In yet another exemplary embodiment, a device that is configured or operable to perform the above-described methods is disclosed. The device may include a processor configured to implement the above-described methods.

In yet another exemplary embodiment, the above-described methods are embodied in the form of processor-executable code and stored in a non-transitory computer-readable storage medium. The code included in the computer readable storage medium when executed by a processor, causes the processor to implement the methods described in this patent document.

The above and other aspects and their implementations are described in greater detail in the drawings, the descriptions, and the claims.

### BRIEF DESCRIPTION OF THE DRAWINGS

FIG. 1 illustrates an artificial intelligence (AI) framework.

FIG. 2 illustrates AI training by a core network (CN) node and AI inference by a gNodeB (gNB).

FIG. 3 illustrates AI training and inference by a gNB.

FIG. 4 illustrates AI training by a central unit (CU) and AI inference by a distributed unit (DU).

FIG. 5 illustrates AI training and inference by a CU.

FIG. 6 illustrates a feedback procedure.

FIG. 7 is an exemplary flowchart for requesting input data.

FIG. 8 is an exemplary flowchart for training an AI function.

FIG. 9 is an exemplary flowchart for determining inference data.

FIG. 10 is an exemplary flowchart for requesting feedback.

FIG. 11 is an exemplary flowchart for transmitting input data.

FIG. 12 illustrates an exemplary block diagram of a hardware platform that may be a part of a network device or a communication device.

FIG. 13 illustrates exemplary wireless communication including a Base Station (BS) and User Equipment (UE) based on some implementations of the disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only and may be used in wireless systems that implemented other protocols.

### I. INTRODUCTION

By using artificial intelligence (AI)/machine learning (ML) technology, radio access network (RAN) node/core network (CN)/distributed unit (DU) or other entities can predict the quality of experience (QoE) measurement data, quality of service (QoS) configuration, and/or minimization of drive test (MDT) measurement data by using the history QoE, QoS, and MDT data and/or provided inference data from other entities. By using the predicted data, network can allocate/re-allocate much more proper 3rd Generation Partnership Project (3GPP)/non-3GPP resources and modify the mobility strategy to the specific user equipments (UEs). Then, the new generated/measurement data will be used as feedback data to evaluate the modification. Based on the evaluation, further received history data (e.g., QoE measurement data, QoS configuration, MDT measurement data, etc.), and the AI/ML technology, the network entities will update the AI model and perform the AI inference.

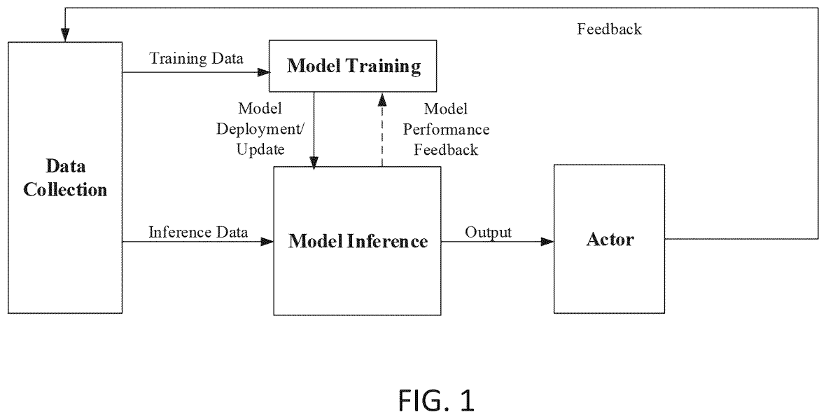

AI/ML technology has been widely used in various fields especially in the industry fields. By the assistance of the AI/ML, the production efficiency has been raised much greater than before. In telecommunication field, AI/ML can also be used to improve the system. For example, AI technology may be applied to beam management in the over-the-air communication interface. In some implementations, beam management typically relies on the exhaustive search of beam sweeping. For another example, AI technology may be applied to channel state information (CSI) feedback. These AI/ML models used in the system may be trained and managed at the various network nodes and may need to be delivered or transferred to other network nodes. The function framework of the RAN intelligence defined in TR 37.817 is shown in FIG. 1.

### II. EMBODIMENT 1

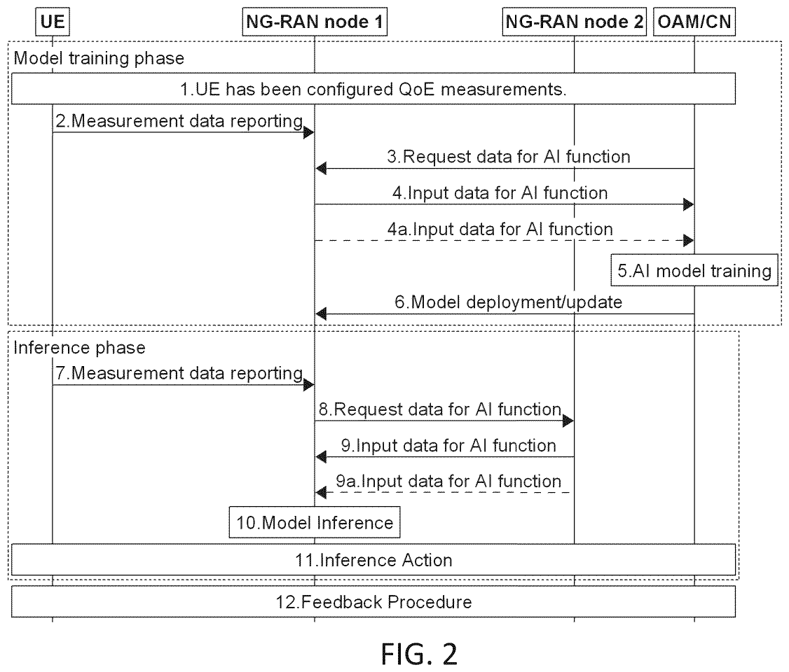

As shown in FIG. 2, Embodiment 1 illustrates AI training by an Operations, Administration and Maintenance (OAM)/CN node and AI inference by a gNodeB (gNB) node.

In this embodiment, CN or OAM is responsible for the AI model training and next-generation (NG) RAN (NG-RAN) node is responsible for the model inference. If CN is involved in this embodiment, then the procedures between CN and NG-RAN node are NG Application Protocol (NGAP) procedures, which will be introduced in the 3GPP protocols. If OAM is involved in this embodiment, the procedures between OAM and NG-RAN node are based on implementation and only stage 2 description may be introduced in the 3GPP protocols.

Before this procedure happens, all involved network entities may have been deployed with the AI model. So that the NG-RAN node 1 and NG-RAN node 2 may provide the inference data when they receive the data requirement in step 3 or 8.
Step 1: UE has been configured QoE measurements and is performing QoE data collection.
Step 2: UE transmits the measurement reports to NG-RAN node 1 periodically.
Step 3: OAM/CN sends message to NG-RAN node 1 and to request data for AI function (e.g., model training). At least one of the following information may be contained in this message.
UE ID(s): one or multiple UE IDs that is used to uniquely mark a UE. NG-RAN node 1 only needs to provide the data for the specific UE(s).
Processing indicator: This indication is used to notify NG-RAN node 1 that the required info may be used for training and/or inference. The NG-RAN node 1 may provide different amount of data based on this indication.
History QoS configuration requirement information: This info is used to request history QoS configuration information that is stored/available in NG-RAN node 1.

This information may contain an indication for the history QoS configuration requirement. In this case, NG-RAN node 1 may provide all history QoS configuration that fulfills the requirement in this message.

This information may contain detailed QoS configuration parameters. In this case, NG-RAN node 1 may provide all history QoS configuration on the specific parameters that fulfills the requirement in this message. At least one of the following parameters may be included in this message.

A history QoS configuration requirement indication, a 5G QoS identifier (5QI) reference, a QoS level identifier, a service type, a packet delay range, a maximum packet delay, a minimum packet delay, an average packet delay, a packet error rate range, a maximum packet error rate, a minimum packet error rate, an average packet error rate, a packet loss rate range, a maximum packet loss rate, a minimum packet loss rate, an average packet loss rate, a guaranteed flow bit rate range, a maximum guaranteed flow bit rate, a minimum guaranteed flow bit rate, and an average guaranteed flow bit rate.
History QoE (RVQoE) requirement information: This information is used to request history QoE information that is available at NG-RAN node 1.

This information may contain an indication for the history QoE requirement. In this case, NG-RAN node 1 may provide all history QoE data that fulfills the requirement in this message.

This information may contain detailed QoE parameters/metrics. In this case, NG-RAN node 1 may provide all history QoE data on the specific parameters/metrics that fulfills the requirement in this message. At least one of the following parameters/metrics may be included in this message.

A history QoE requirement indication, a QoE level identifier, a service type, an area scope, a QoE type (signaling based QoE, management based QoE), RAN-visible QoE data, a QoE report container, a codec rate, a QoE score, a QoE metric range, a maximum QoE metric, a minimum QoE metric, an average QoE metric (where QoE score could be a number range, e.g., 0 to 10, where 10 represents excellent quality and 0 represents poor quality; or QoE score could be an enumerated type to indicate the quality, e.g., (poor, medium, good); where QoE metrics is a subset of QoE metrics data guaranteed for UE, e.g., a round-trip time, a jitter duration, a corruption duration, a throughput, an initial playout delay for video, a video resolution, a buffer occupancy level, etc.
History MDT data requirement information: This information is used to request history MDT information that is available at NG-RAN node 1.

This information may contain an indication for the history MDT data requirement. In this case, NG-RAN node 1 may provide all history MDT data that fulfills the requirement in this message.

This information may contain detailed MDT parameters/metrics. In this case, NG-RAN node 1 may provide all history MDT data on the specific parameters/metrics that fulfills the requirement in this message. At least one of the following parameters/metrics may be included in this message.
M1: downlink (DL) signal quantities measurement results for the serving cell and for intra-frequency/inter-frequency/inter-radio access technology (RAT) neighbor cells, including cell/beam level measurement for new radio (NR) cells only.
M2: Power Headroom measurement by UE.
M3: Received Interference Power measurement.
M4: Data Volume measurement separately for DL and uplink (UL), per Data Radio Bearer (DRB) per UE.
M5: Average UE throughout measurement separately for DL and UL, per DRB per UE and per UE for the DL, per DRB per UE and per UE for the UL, by gNB.
M6: Packet Delay measurement separately for DL and UL, per DRB per UE.
M7: Packet loss rate measurement separately for DL and UL, per DRB per UE.
M8: Received Signal Strength Indicator (RSSI) measurement by UE (for wireless local area network (WLAN)/Bluetooth measurement).
M9: Round Trip Time (RTT) Measurement by UE (for WLAN measurement).
Inference QoS data requirement: This information is used to request inference QoS information that is available at NG-RAN node 1.

This information may contain an indication for the inference QoS configuration requirement. In this case, NG-RAN node 1 may provide all inference QoS configuration that fulfills the requirement in this message.

This information may contain detailed QoS configuration parameters. In this case, NG-RAN node 1 may provide all inference QoS configuration on the specific parameters that fulfills the requirement in this message. At least one of the following parameters may be included in this message.
Inference QoS configuration requirement indication: This is used to indicate that NG-RAN node 1 needs to provide the inference QoS data.

5QI reference or QoS level identifier, Service Type, Packet Delay range, maximum Packet Delay, minimum Packet Delay, average Packet Delay, Packet Error Rate range, maximum Packet Error Rate, minimum Packet Error Rate, average Packet Error Rate, Packet Loss Rate range, maximum Packet Loss Rate, minimum Packet Loss Rate, average Packet Loss Rate, Guaranteed Flow Bit Rate range, maximum Guaranteed Flow Bit Rate, minimum Guaranteed Flow Bit Rate, average Guaranteed Flow Bit Rate.
Inference QoE data requirement: This information is used to request inference QoE information that is available at NG-RAN node 1.

This information may contain an indication for the inference QoE requirement. In this case, NG-RAN node 1 may provide all inference QoE data that fulfills the requirement in this message.

This information may contain detailed QoE parameters/metrics. In this case, NG-RAN node 1 may provide all inference QoE data on the specific parameters/metrics that fulfills the requirement in this message. At least one of the following parameters/metrics may be included in this message.
Inference QoE requirement indication: This is used to indicate that NG-RAN node 1 needs to provide the inference QoE data.

QoE level identifier, service type, area scope, QoE type (signaling based QoE, management based QoE), RAN visible QoE data, QoE report container, Codec rate, QoE Score, QoE metrics range, maximum QoE metrics, minimum QoE metrics, average QoE metrics, where QoE score could be a number range, e.g., 0 to 10, where 10 represents excellent quality and 0 represents poor quality; or QoE score could be an enumerated type to indicate the quality, e.g., (poor, medium, good); where QoE metrics is a subset of QoE metrics data guaranteed for UE, e.g., Round-trip time, Jitter duration, Corruption duration, Throughput, Initial playout delay for video, video resolution, buffer occupancy level, etc.
Inference MDT data requirement: This information is used to request inference MDT information that is available at NG-RAN node 1.

This information may contain an indication for the inference MDT info requirement. In this case, NG-RAN node 1 may provide all inference MDT data that fulfills the requirement in this message.

This information may contain detailed MDT parameters/metrics. In this case, NG-RAN node 1 may provide all inference MDT data on the specific parameters/metrics that fulfills the requirement in this message. At least one of the following parameters/metrics may be included in this message.
Inference MDT requirement indication: This is used to indicate that NG-RAN node 1 needs to provide the inference MDT data.
M1: DL signal quantities measurement results for the serving cell and for intra-frequency/Inter-frequency/inter-RAT neighbor cells, including cell/beam level measurement for NR cells only.
M2: Power Headroom measurement by UE.
M3: Received Interference Power measurement.
M4: Data Volume measurement separately for DL and UL, per DRB per UE.
M5: Average UE throughout measurement separately for DL and UL, per DRB per UE and per UE for the DL, per DRB per UE and per UE for the UL, by gNB.
M6: Packet Delay measurement separately for DL and UL, per DRB per UE.
M7: Packet loss rate measurement separately for DL and UL, per DRB per UE.
M8: RSSI measurement by UE (for WLAN/Bluetooth measurement).
M9: RTT Measurement by UE (for WLAN measurement).
Confidence requirement of the inference data: This is an information element with the value from 0 to 100 (or may be a ratio). It is used to mark the level of trust/accuracy the inference data should be. NG-RAN node 1 can only provide the inference data if the confidence of this inference data is not lower than this threshold. Each inference data type (QoE, QoS, MDT) may have one related confidence requirement. In another alternative, one confidence info may be used to limit all inference data in this message.

### Time Related Information.

Time information of the needed data: CN/OAM may request NG-RAN node 1 to provide a chunk of data in a certain duration (or start & end time) for specific UE(s).
Reporting frequency: NG-RAN node 1 may transmit the needed data for specific UE(s) to CN/OAM periodically.

The time related info may co-exist in the message. If so, NG-RAN node shall send a chunk of data that fulfills the duration limitation in “Time information of the needed data” in the first response message. Then NG-RAN node 1 may send the rest of stored data or newly generated data to OAM/CN by using configured “reporting frequency.”
Step 4: Based on the received requirement in step 3, NG-RAN node 1 may transmit the required data for AI function to OAM/CN. At least one of the following info may be contained in the message.
UE ID(s): one or multiple UE IDs that is used to uniquely mark a UE. NG-RAN node 1 only needs to provide the history data for the specific UE(s).
Empty indicator: This optional indicator will be sent to CN/OAM if there is no available info at NG-RAN node 1 side.

History QoE data, and/or history QoS data, and/or history MDT data will be added in this message if available. Detailed parameters/metrics of this data can be found in step 3.

Inference QoE data, and/or inference QoS data, and/or inference MDT data will be added in this message if available. Detailed parameters/metrics of this data can be found in step 3.
Confidence information of the inference data: This is an information element with the value from 0 to 100 (or may be a ratio) that is generated by NG-RAN node 1. It is used to mark the level of trust/accuracy the inference data should be. Each inference data type (QoE, QoS, MDT) may has one related confidence information. In another alternative, one confidence info may be used to mark all inference data in this message.
Time information of the data: The time information of the provided data. It may be start & end time, duration.
Step 4a: If the data is oversized or needs to be transmitted periodically, multiple messages will be used for data transmission. At least one of the following info may be contained in the message.
UE ID(s): one or multiple UE IDs that is used to uniquely mark a UE. NG-RAN node 1 only needs to provide the history data for the specific UE(s).
Empty indicator: This optional indicator will be sent to CN/OAM if there is no available info at NG-RAN node 1 side.

History QoE data, and/or history QoS data, and history MDT data will be added in this message if available. Detailed parameters/metrics of this data can be found in step 3.

Inference QoE data, and/or inference QoS data, and inference MDT data will be added in this message if available. Detailed parameters/metrics of this data can be found in step 3.
Confidence information of the inference data: This is an information element with the value from 0 to 100 (or may be a ratio) that is generated by NG-RAN node 1. It is used to mark the level of trust/accuracy the inference data should be. Each inference data type (QoE, QoS, MDT) may has one related confidence information. In another alternative, one confidence info may be used to mark all inference data in this message.
Time information of the data: The time information of the provided data. It may be start & end time, duration.
Step 5: After collecting enough data, CN/OAM may perform the AI model training progress with enabled AI/ML function.

This step may be reflected in the 3GPP specifications as stage 2 description.
Step 6: After CN/OAM generates the AI model, the new model will be deployed/updated to the NG-RAN node 1.
Step 7: UE keeps sending measurement data to NG-RAN node 1 (if any).
Step 8: NG-RAN node 1 sends message to NG-RAN node 2 and to request data for AI function (e.g., model inference). At least one of the following information may be contained in this message.
UE ID(s): one or multiple UE IDs that is used to uniquely mark a UE. NG-RAN node 2 only needs to provide data for the specific UE(s).
Processing indicator: This indication is used to notice NG-RAN node 2 that the required info may be used for online training and/or inference. The NG-RAN node 2 may provide different amount of data based on this indication.
History QoS configuration requirement information: This info is used to request history QoS configuration information that is stored/available in NG-RAN node 2.

This information may contain an indication for the history QoS configuration requirement. In this case, NG-RAN node 2 may provide all history QoS configuration that fulfills the requirement in this message.

This information may contain detailed QoS configuration parameters. In this case, NG-RAN node 2 may provide all history QoS configuration on the specific parameters that fulfills the requirement in this message. At least one of the following parameters may be included in this message.

History QoS configuration requirement indication, 5QI reference or QoS level identifier, Service Type, Packet Delay range, maximum Packet Delay, minimum Packet Delay, average Packet Delay, Packet Error Rate range, maximum Packet Error Rate, minimum Packet Error Rate, average Packet Error Rate, Packet Loss Rate range, maximum Packet Loss Rate, minimum Packet Loss Rate, average Packet Loss Rate, Guaranteed Flow Bit Rate range, maximum Guaranteed Flow Bit Rate, minimum Guaranteed Flow Bit Rate, average Guaranteed Flow Bit Rate.
History QoE (RVQoE) requirement information: This info is used to request history QoE information that is available at NG-RAN node 2.

This information may contain an indication for the history QoE requirement. In this case, NG-RAN node 2 may provide all history QoE data that fulfills the requirement in this message.

This information may contain detailed QoE parameters/metrics. In this case, NG-RAN node 2 may provide all history QoE data on the specific parameters/metrics that fulfills the requirement in this message. At least one of the following parameters/metrics may be included in this message.

History QoE requirement indication, QoE level identifier, service type, area scope, QoE type (signaling based QoE, management based QoE), RAN visible QoE data, QoE report container, Codec rate, QoE Score, QoE metrics range, maximum QoE metrics, minimum QoE metrics, average QoE metrics. where QoE score could be a number range, e.g., 0 to 10. where 10 represents excellent quality and 0 represents poor quality, or QoE score could be an enumerated type to indicate the quality, e.g., (poor, medium, good); where QoE metrics is a subset of QoE metrics data guaranteed for UE, e.g., Round-trip time, Jitter duration, Corruption duration, Throughput, Initial playout delay for video, video resolution, buffer occupancy level, etc.
History MDT info requirement information: This info is used to request history MDT information that is available at NG-RAN node 2.

This information may contain an indication for the history MDT info requirement. In this case, NG-RAN node 2 may provide all history MDT data that fulfills the requirement in this message.

This information may contain detailed MDT parameters/metrics. In this case, NG-RAN node 2 may provide all history MDT data on the specific parameters/metrics that fulfills the requirement in this message. At least one of the following parameters/metrics may be included in this message.
M1: DL signal quantities measurement results for the serving cell and for intra-frequency/Inter-frequency/inter-RAT neighbor cells, including cell/beam level measurement for NR cells only.
M2: Power Headroom measurement by UE.
M3: Received Interference Power measurement.
M4: Data Volume measurement separately for DL and UL, per DRB per UE.
M5: Average UE throughout measurement separately for DL and UL, per DRB per UE and per UE for the DL, per DRB per UE and per UE for the UL, by gNB.
M6: Packet Delay measurement separately for DL and UL, per DRB per UE.
M7: Packet loss rate measurement separately for DL and UL, per DRB per UE.
M8: RSSI measurement by UE (for WLAN/Bluetooth measurement).
M9: RTT Measurement by UE (for WLAN measurement).
Inference QoS data requirement: This info is used to request inference QoS information that is available at NG-RAN node 2.

This information may contain an indication for the inference QoS configuration requirement. In this case, NG-RAN node 2 may provide all inference QoS configuration that fulfills the requirement in this message.

This information may contain detailed QoS configuration parameters. In this case, NG-RAN node 2 may provide all inference QoS configuration on the specific parameters that fulfills the requirement in this message. At least one of the following parameters may be included in this message.
Inference QoS configuration requirement indication: This is used to indicate that NG-RAN node 2 needs to provide the inference QoS data.

5QI reference or QoS level identifier, Service Type, Packet Delay range, maximum Packet Delay, minimum Packet Delay, average Packet Delay, Packet Error Rate range, maximum Packet Error Rate, minimum Packet Error Rate, average Packet Error Rate, Packet Loss Rate range, maximum Packet Loss Rate, minimum Packet Loss Rate, average Packet Loss Rate, Guaranteed Flow Bit Rate range, maximum Guaranteed Flow Bit Rate, minimum Guaranteed Flow Bit Rate, average Guaranteed Flow Bit Rate.
Inference QoE data requirement: This info is used to request inference QoE information that is available at NG-RAN node 2.

This information may contain an indication for the inference QoE requirement. In this case, NG-RAN node 2 may provide all inference QoE data that fulfills the requirement in this message.

This information may contain detailed QoE parameters/metrics. In this case, NG-RAN node 2 may provide all inference QoE data on the specific parameters/metrics that fulfills the requirement in this message. At least one of the following parameters/metrics may be included in this message.
Inference QoE requirement indication: This is used to indicate that NG-RAN node 2 needs to provide the inference QoE data.

Start time and end time of this inference data or the duration of this inference data.

QoE level identifier, service type, area scope, QoE type (signaling based QoE, management based QoE), RAN visible QoE data, QoE report container, Codec rate, QoE Score, QoE metrics range, maximum QoE metrics, minimum QoE metrics, average QoE metrics, where QoE score could be a number range, e.g., 0 to 10. where 10 represents excellent quality and 0 represents poor quality; or QoE score could be an enumerated type to indicate the quality, e.g., (poor, medium, good); where QoE metrics is a subset of QoE metrics data guaranteed for UE, e.g., Round-trip time, Jitter duration, Corruption duration, Throughput, Initial playout delay for video, video resolution, buffer occupancy level, etc.
Inference MDT data requirement: This info is used to request inference MDT information that is available at NG-RAN node 2.

This information may contain an indication for the inference MDT info requirement. In this case, NG-RAN node 2 may provide all inference MDT data that fulfills the requirement in this message.

This information may contain detailed MDT parameters/metrics. In this case, NG-RAN node 2 may provide all inference MDT data on the specific parameters/metrics that fulfills the requirement in this message. At least one of the following parameters/metrics may be included in this message.
Inference MDT requirement indication: This is used to indicate that NG-RAN node 2 needs to provide the inference MDT data.
M1: DL signal quantities measurement results for the serving cell and for intra-frequency/Inter-frequency/inter-RAT neighbor cells, including cell/beam level measurement for NR cells only.
M2: Power Headroom measurement by UE.
M3: Received Interference Power measurement.
M4: Data Volume measurement separately for DL and UL, per DRB per UE.
M5: Average UE throughout measurement separately for DL and UL, per DRB per UE and per UE for the DL, per DRB per UE and per UE for the UL, by gNB.
M6: Packet Delay measurement separately for DL and UL, per DRB per UE.
M7: Packet loss rate measurement separately for DL and UL, per DRB per UE.
M8: RSSI measurement by UE (for WLAN/Bluetooth measurement).
M9: RTT Measurement by UE (for WLAN measurement).
Confidence requirement of the inference data: This is an information element with the value from 0 to 100 (or may be a ratio). It is used to mark the level of trust/accuracy the inference data should be. NG-RAN node 2 can only provide the inference data if the confidence of this inference data is not lower than this threshold. Each inference data type (QoE, QoS, MDT) may have one related confidence requirement. In another alternative, one confidence info may be used to limit all inference data in this message.

### Time Related Information.

Time information of the needed data: NG-RAN node 1 may request NG-RAN node 2 to provide a chunk of data in a certain duration (or start & end time) for specific UE(s).
Reporting frequency: NG-RAN node 2 may transmit the needed data for specific UE(s) to NG-RAN node 1 periodically.

The time related info may co-exist in the message. If so, NG-RAN node 2 shall send a chunk of data that fulfills the duration limitation in “Time information of the needed data” in the first response message. Then NG-RAN node 2 may send the rest of stored data or newly generated data to OAM/CN by using configured “reporting frequency.”
Feedback request indication: This indication is used for NG-RAN node 1 to ask for feedback of the inference. With this indication, after NG-RAN node 2 receives the inference data from NG-RAN node 1, it shall send the feedback info to NG-RAN node 1 if available.
Step 9: Based on the received requirement in step 8, NG-RAN node 2 may transmit the required data for AI function to NG-RAN node 1. At least one of the following info may be contained in the message.
UE ID(s): one or multiple UE IDs that is used to uniquely mark a UE. NG-RAN node 2 only needs to provide the history data for the specific UE(s).
Empty indicator: This optional indicator will be sent to NG-RAN node 1 if there is no available info at NG-RAN node 2 side.

History QoE data, history QoS data, and history MDT data will be added in this message if available. Detailed parameters/metrics of this data can be found in step 8.

Inference QoE data, inference QoS data, and inference MDT data will be added in this message if available. Detailed parameters/metrics of this data can be found in step 8.
Confidence information of the inference data: This is an information element with the value from 0 to 100 (or may be a ratio) that is generated by NG-RAN node 2. It is used to mark the level of trust/accuracy the inference data should be. Each inference data type (QoE, QoS, MDT) may have one related confidence information. In another alternative, one confidence info may be used to mark all inference data in this message.
Time information of the history data: The time information of the provided data.
Step 9a: If the history data is oversized or needs to be transmitted periodically, more than one message will be used for history data transmission. At least one of the following info may be contained in the message.
UE ID(s): one or multiple UE IDs that is used to uniquely mark a UE. NG-RAN node 2 only needs to provide the history data for the specific UE(s).
Empty indicator: This optional indicator will be sent to NG-RAN node 1 if there is no available info at NG-RAN node 2 side.

History QoE data, and/or history QoS data, and/or history MDT data will be added in this message if available. Detailed parameters/metrics of this data can be found in step 8.

Inference QoE data, and/or inference QoS data, and/or inference MDT data will be added in this message if available. Detailed parameters/metrics of this data can be found in step 8.
Confidence information of the inference data: This is an information element with the value from 0 to 100 (or may be a ratio) that is generated by NG-RAN node 2. It is used to mark the level of trust/accuracy the inference data should be. Each inference data type (QoE, QoS, MDT) may have one related confidence information. In another alternative, one confidence info may be used to mark all inference data in this message.
Time information of the history data: The time information of the provided data.
Step 10: After collecting enough data, NG-RAN node 1 may perform the AI model inference progress with enabled AI/ML function. The predicted QoE data and/or predicted QoS configuration and/or predicted MDT configuration/data for specific UE(s) for next following timing(s) will be generated by NG-RAN node 1.

This step may be reflected in the 3GPP specifications as stage 2 description.
Step 11: After model inference, NG-RAN node 1 may trigger the inference action procedure. With the assistance of the inference/predicted QoE, QoS data, the NG-RAN node 1 may perform some processes not limited to the following ones.

NG-RAN node 1 may re-allocate the 3GPP/non-3GPP resources for each UE in this NG-RAN node.

NG-RAN node 1 may update the mobility strategy of the specific UE(s).

NG-RAN node 1 may send inference/predicted data to other NG-RAN nodes for inference procedure.

NG-RAN node 1 may send the inference/predicted data to CN/OAM for further QoS/QoE configuration, etc.

This step may be reflected in the 3GPP specifications as stage 2 description.
Step 12: Detailed description of the feedback procedure can be found in embodiment 5.

### III. EMBODIMENT 2

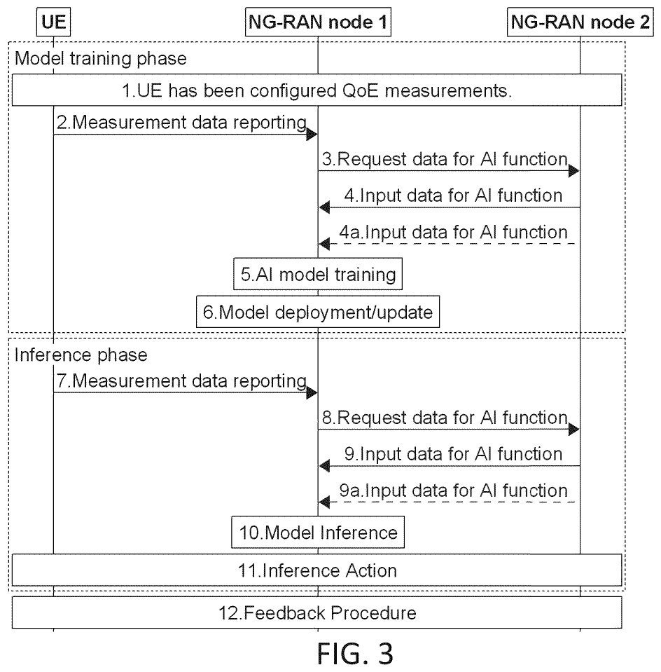

As shown in FIG. 3, Embodiment 2 illustrates AI training and inference by a gNB.

The involved procedure between NG-RAN nodes is Xn Application Protocol (XnAP) enhancement.

Before this procedure happens, all involved network entities may have been deployed with the AI model. So that the NG-RAN node 1 and NG-RAN node 2 may provide the inference data when they receive the data requirement in step 3/8.
Step 1: UE has been configured QoE measurements and is performing QoE data collection.
Step 2: UE transmits the measurement reports to NG-RAN node 1 periodically.
Step 3: NG-RAN node 1 sends message to NG-RAN node 2 and to request data for AI function (e.g., model training). At least one of the following information may be contained in this message.
UE ID(s): one or multiple UE IDs that is used to uniquely mark a UE. NG-RAN node 2 only needs to provide the history data for the specific UE(s).
Processing indicator: This indication is used to notify NG-RAN node 2 that the required info may be used for online training and/or inference. The NG-RAN node 2 may provide different amount of data based on this indication.
History QoS configuration requirement information: This info is used to request history QoS configuration information that is stored/available in NG-RAN node 2.

This information may contain an indication for the history QoS configuration requirement. In this case, NG-RAN node 2 may provide all history QoS configuration that fulfills the requirement for specific UE(s) in this message.

This information may contain detailed QoS configuration parameters. In this case, NG-RAN node 2 may provide all history QoS configuration on the specific parameters that fulfills the requirement for specific UE(s) in this message. At least one of the following parameters may be included in this message.

History QoS configuration requirement indication, 5QI reference or QoS level identifier, Service Type, Packet Delay range, maximum Packet Delay, minimum Packet Delay, average Packet Delay, Packet Error Rate range, maximum Packet Error Rate, minimum Packet Error Rate, average Packet Error Rate, Packet Loss Rate range, maximum Packet Loss Rate, minimum Packet Loss Rate, average Packet Loss Rate, Guaranteed Flow Bit Rate range, maximum Guaranteed Flow Bit Rate, minimum Guaranteed Flow Bit Rate, average Guaranteed Flow Bit Rate.
History QoE (RVQoE) requirement information: This info is used to request history QoE information that is available at NG-RAN node 2.

This information may contain an indication for the history QoE requirement. In this case, NG-RAN node 2 may provide all history QoE data that fulfills the requirement for specific UE(s) in this message.

This information may contain detailed QoE parameters/metrics. In this case, NG-RAN node 2 may provide all history QoE data on the specific parameters/metrics that fulfills the requirement for specific UE(s) in this message. At least one of the following parameters/metrics may be included in this message.

History QoE requirement indication, QoE level identifier, service type, area scope, QoE type (signaling based QoE, management based QoE), RAN visible QoE data, QoE report container, Codec rate, QoE Score, QoE metrics range, maximum QoE metrics, minimum QoE metrics, average QoE metrics, where QoE score could be a number range, e.g., 0 to 10, where 10 represents excellent quality and 0 represents poor quality; or QoE score could be an enumerated type to indicate the quality, e.g., (poor, medium, good); where QoE metrics is a subset of QoE metrics data guaranteed for UE, e.g., Round-trip time, Jitter duration, Corruption duration, Throughput, Initial playout delay for video, video resolution, buffer occupancy level, etc.
History MDT info requirement information: This info is used to request history MDT information that is available at NG-RAN node 2.

This information may contain an indication for the history MDT info requirement. In this case, NG-RAN node 2 may provide all history MDT data that fulfills the requirement for specific UE(s) in this message.

This information may contain detailed MDT parameters/metrics. In this case, NG-RAN node 1 may provide all history MDT data on the specific parameters/metrics that fulfills the requirement for specific UE(s) in this message. At least one of the following parameters/metrics may be included in this message.
M1: DL signal quantities measurement results for the serving cell and for intra-frequency/Inter-frequency/inter-RAT neighbor cells, including cell/beam level measurement for NR cells only.
M2: Power Headroom measurement by UE.
M3: Received Interference Power measurement.
M4: Data Volume measurement separately for DL and UL, per DRB per UE.
M5: Average UE throughout measurement separately for DL and UL, per DRB per UE and per UE for the DL, per DRB per UE and per UE for the UL, by gNB.
M6: Packet Delay measurement separately for DL and UL, per DRB per UE.
M7: Packet loss rate measurement separately for DL and UL, per DRB per UE.
M8: RSSI measurement by UE (for WLAN/Bluetooth measurement).
M9: RTT Measurement by UE (for WLAN measurement).
Inference QoS data requirement: This info is used to request inference QoS information that is available at NG-RAN node 2 for specific UE(s).

This information may contain an indication for the inference QoS configuration requirement. In this case, NG-RAN node 2 may provide all inference QoS configuration that fulfills the requirement in this message.

This information may contain detailed QoS configuration parameters. In this case, NG-RAN node 2 may provide all inference QoS configuration on the specific parameters that fulfills the requirement for specific UE(s) in this message. At least one of the following parameters may be included in this message.
Inference QoS configuration requirement indication: This is used to indicate that NG-RAN node 2 needs to provide the inference QoS data.

5QI reference or QoS level identifier, Service Type, Packet Delay range, maximum Packet Delay, minimum Packet Delay, average Packet Delay, Packet Error Rate range, maximum Packet Error Rate, minimum Packet Error Rate, average Packet Error Rate, Packet Loss Rate range, maximum Packet Loss Rate, minimum Packet Loss Rate, average Packet Loss Rate, Guaranteed Flow Bit Rate range, maximum Guaranteed Flow Bit Rate, minimum Guaranteed Flow Bit Rate, average Guaranteed Flow Bit Rate.
Inference QoE data requirement: This info is used to request inference QoE information that is available at NG-RAN node 2 for specific UE(s).

This information may contain an indication for the inference QoE requirement. In this case, NG-RAN node 2 may provide all inference QoE data that fulfills the requirement in this message.

This information may contain detailed QoE parameters/metrics. In this case, NG-RAN node 2 may provide all inference QoE data on the specific parameters/metrics that fulfills the requirement in this message. At least one of the following parameters/metrics may be included in this message.
Inference QoE requirement indication: This is used to indicate that NG-RAN node 2 needs to provide the inference QoE data.

QoE level identifier, service type, area scope, QoE type (signaling based QoE, management based QoE), RAN visible QoE data, QoE report container, Codec rate, QoE Score, QoE metrics range, maximum QoE metrics, minimum QoE metrics, average QoE metrics, where QoE score could be a number range, e.g., 0 to 10, where 10 represents excellent quality and 0 represents poor quality; or QoE score could be an enumerated type to indicate the quality, e.g., (poor, medium, good); where QoE metrics is a subset of QoE metrics data guaranteed for UE, e.g., Round-trip time, Jitter duration, Corruption duration, Throughput, Initial playout delay for video, video resolution, buffer occupancy level, etc.
Inference MDT data requirement: This info is used to request inference MDT information that is available at NG-RAN node 2 for specific UE(s).

This information may contain an indication for the inference MDT info requirement. In this case, NG-RAN node 2 may provide all inference MDT data that fulfills the requirement in this message.

This information may contain detailed MDT parameters/metrics. In this case, NG-RAN node 2 may provide all inference MDT data on the specific parameters/metrics that fulfills the requirement in this message. At least one of the following parameters/metrics may be included in this message.
Inference MDT requirement indication: This is used to indicate that NG-RAN node 2 needs to provide the inference MDT data.
M1: DL signal quantities measurement results for the serving cell and for intra-frequency/Inter-frequency/inter-RAT neighbor cells, including cell/beam level measurement for NR cells only.
M2: Power Headroom measurement by UE.
M3: Received Interference Power measurement.
M4: Data Volume measurement separately for DL and UL, per DRB per UE.
M5: Average UE throughout measurement separately for DL and UL, per DRB per UE and per UE for the DL, per DRB per UE and per UE for the UL, by gNB.
M6: Packet Delay measurement separately for DL and UL, per DRB per UE.
M7: Packet loss rate measurement separately for DL and UL, per DRB per UE.
M8: RSSI measurement by UE (for WLAN/Bluetooth measurement).
M9: RTT Measurement by UE (for WLAN measurement).
Confidence requirement of the inference data: This is an information element with the value from 0 to 100 (or may be a ratio). It is used to mark the level of trust/accuracy the inference data should be. NG-RAN node 2 can only provide the inference data if the confidence of this inference data is not lower than this threshold. Each inference data type (QoE, QoS, MDT) may has one related confidence requirement. In another alternative, one confidence info may be used to limit all inference data in this message.

### Time Related Information.

Time information of the needed data: NG-RAN node 1 may request NG-RAN node 2 to provide a chunk of data in a certain duration (or start & end time) for specific UE(s).
Reporting frequency: NG-RAN node 2 may transmit the needed data for specific UE(s) to NG-RAN node 1 periodically.

The time related info may co-exist in the message. If so, NG-RAN node 2 shall send a chunk of data that fulfills the duration limitation in “Time information of the needed data” in the first response message. Then NG-RAN node 2 may send the rest of stored data or newly generated data to NG-RAN node 1 by using configured “reporting frequency.”
Step 4: Based on the received requirement in step 3, NG-RAN node 2 may transmit the required data for AI function to NG-RAN node 1. At least one of the following info may be contained in the message.
UE ID(s): one or multiple UE IDs that is used to uniquely mark a UE. NG-RAN node 1 only needs to provide the required data for the specific UE(s).
Empty indicator: This optional indicator will be sent to NG-RAN node 1 if there is no available info at NG-RAN node 2 side.

History QoE data, and/or history QoS data, and/or history MDT data will be added in this message if available. Detailed parameters/metrics of this data can be found in step 3.

Inference QoE data, and/or inference QoS data, and/or inference MDT data will be added in this message if available. Detailed parameters/metrics of this data can be found in step 3.
Confidence information of the inference data: This is an information element with the value from 0 to 100 (or may be a ratio) that is generated by NG-RAN node 1. It is used to mark the level of trust/accuracy the inference data should be. Each inference data type (QoE, QoS, MDT) may has one related confidence information. In another alternative, one confidence info may be used to mark all inference data in this message.
Time information of the data: The time information of the provided data. It may be start & end time, duration.
Step 4a: If the data is oversized or needs to be transmitted periodically, multiple messages will be used for data transmission. At least one of the following info may be contained in the message.
UE ID(s): one or multiple UE IDs that is used to uniquely mark a UE. NG-RAN node 1 only needs to provide the required data for the specific UE(s).
Empty indicator: This optional indicator will be sent to NG-RAN node 1 if there is no available info at NG-RAN node 2 side.

History QoE data, and/or history QoS data, and/or history MDT data will be added in this message if available. Detailed parameters/metrics of this data can be found in step 3.

Inference QoE data, and/or inference QoS data, and/or inference MDT data will be added in this message if available. Detailed parameters/metrics of this data can be found in step 3.
Confidence information of the inference data: This is an information element with the value from 0 to 100 (or may be a ratio) that is generated by NG-RAN node 1. It is used to mark the level of trust/accuracy the inference data should be. Each inference data type (QoE, QoS, MDT) may have one related confidence information. In another alternative, one confidence info may be used to mark all inference data in this message.
Time information of the data: The time information of the provided data. It may be start & end time, duration.
Step 5: After collecting enough data, NG-RAN node 1 may perform the AI model training progress with enabled AI/ML function.

This step may be reflected in the 3GPP specifications as stage 2 description.
Step 6: After NG-RAN node 1 generates the AI model, the new model will be deployed/updated to the NG-RAN node 1.
Step 7: UE keeps sending measurement data to NG-RAN node 1 (if any).
Step 8: NG-RAN node 1 sends message to NG-RAN node 2 and to request data for AI function (e.g., model inference). At least one of the following information may be contained in this message.
UE ID(s): one or multiple UE IDs that is used to uniquely mark a UE. NG-RAN node 1 only needs to provide the required data for the specific UE(s).
Processing indicator: This indication is used to notice NG-RAN node 1 that the required info may be used for online training and/or inference. The NG-RAN node 2 may provide different amount of data based on this indication.
History QoS configuration requirement information: This info is used to request history QoS configuration information that is stored/available in NG-RAN node 2.

This information may contain an indication for the history QoS configuration requirement. In this case, NG-RAN node 2 may provide all history QoS configuration that fulfills the requirement in this message.

This information may contain detailed QoS configuration parameters. In this case, NG-RAN node 2 may provide all history QoS configuration on the specific parameters that fulfills the requirement in this message. At least one of the following parameters may be included in this message.

History QoS configuration requirement indication, 5QI reference or QoS level identifier, Service Type, Packet Delay range, maximum Packet Delay, minimum Packet Delay, average Packet Delay, Packet Error Rate range, maximum Packet Error Rate, minimum Packet Error Rate, average Packet Error Rate, Packet Loss Rate range, maximum Packet Loss Rate, minimum Packet Loss Rate, average Packet Loss Rate, Guaranteed Flow Bit Rate range, maximum Guaranteed Flow Bit Rate, minimum Guaranteed Flow Bit Rate, average Guaranteed Flow Bit Rate.
History QoE (RVQoE) requirement information: This info is used to request history QoE information that is available at NG-RAN node 2.

This information may contain an indication for the history QoE requirement. In this case, NG-RAN node 2 may provide all history QoE data that fulfills the requirement in this message.

This information may contain detailed QoE parameters/metrics. In this case, NG-RAN node 2 may provide all history QoE data on the specific parameters/metrics that fulfills the requirement in this message. At least one of the following parameters/metrics may be included in this message.

History QoE requirement indication, QoE level identifier, service type, area scope, QoE type (signaling based QoE, management based QoE), RAN visible QoE data, QoE report container, Codec rate, QoE Score, QoE metrics range, maximum QoE metrics, minimum QoE metrics, average QoE metrics, where QoE score could be a number range, e.g., 0 to 10, where 10 represents excellent quality and 0 represents poor quality; or QoE score could be a enumerated type to indicate the quality, e.g., (poor, medium, good); where QoE metrics is a subset of QoE metrics data guaranteed for UE, e.g., Round-trip time, Jitter duration, Corruption duration, Throughput, Initial playout delay for video, video resolution, buffer occupancy level, etc.
History MDT info requirement information: This info is used to request history MDT information that is available at NG-RAN node 2.

This information may contain an indication for the history MDT info requirement. In this case, NG-RAN node 2 may provide all history MDT data that fulfills the requirement in this message.

This information may contain detailed MDT parameters/metrics. In this case, NG-RAN node 2 may provide all history MDT data on the specific parameters/metrics that fulfills the requirement in this message. At least one of the following parameters/metrics may be included in this message.
M1: DL signal quantities measurement results for the serving cell and for intra-frequency/Inter-frequency/inter-RAT neighbor cells, including cell/beam level measurement for NR cells only.
M2: Power Headroom measurement by UE.
M3: Received Interference Power measurement.
M4: Data Volume measurement separately for DL and UL, per DRB per UE.
M5: Average UE throughout measurement separately for DL and UL, per DRB per UE and per UE for the DL, per DRB per UE and per UE for the UL, by gNB.
M6: Packet Delay measurement separately for DL and UL, per DRB per UE.
M7: Packet loss rate measurement separately for DL and UL, per DRB per UE.
M8: RSSI measurement by UE (for WLAN/Bluetooth measurement).
M9: RTT Measurement by UE (for WLAN measurement).
Inference QoS data requirement: This info is used to request inference QoS information that is available at NG-RAN node 2.

This information may contain an indication for the inference QoS configuration requirement. In this case, NG-RAN node 2 may provide all inference QoS configuration that fulfills the requirement in this message.

This information may contain detailed QoS configuration parameters. In this case, NG-RAN node 2 may provide all inference QoS configuration on the specific parameters that fulfills the requirement in this message. At least one of the following parameters may be included in this message.
Inference QoS configuration requirement indication: This is used to indicate that NG-RAN node 2 needs to provide the inference QoS data.

5QI reference or QoS level identifier, Service Type, Packet Delay range, maximum Packet Delay, minimum Packet Delay, average Packet Delay, Packet Error Rate range, maximum Packet Error Rate, minimum Packet Error Rate, average Packet Error Rate, Packet Loss Rate range, maximum Packet Loss Rate, minimum Packet Loss Rate, average Packet Loss Rate, Guaranteed Flow Bit Rate range, maximum Guaranteed Flow Bit Rate, minimum Guaranteed Flow Bit Rate, average Guaranteed Flow Bit Rate.
Inference QoE data requirement: This info is used to request inference QoE information that is available at NG-RAN node 2.

This information may contain an indication for the inference QoE requirement. In this case, NG-RAN node 2 may provide all inference QoE data that fulfills the requirement in this message.

This information may contain detailed QoE parameters/metrics. In this case, NG-RAN node 2 may provide all inference QoE data on the specific parameters/metrics that fulfills the requirement in this message. At least one of the following parameters/metrics may be included in this message.
Inference QoE requirement indication: This is used to indicate that NG-RAN node 2 needs to provide the inference QoE data.

Start time and end time of this inference data or the duration of this inference data.

QoE level identifier, service type, area scope, QoE type (signaling based QoE, management based QoE), RAN visible QoE data, QoE report container, Codec rate, QoE Score, QoE metrics range, maximum QoE metrics, minimum QoE metrics, average QoE metrics, where QoE score could be a number range, e.g., 0 to 10, where 10 represents excellent quality and 0 represents poor quality; or QoE score could be an enumerated type to indicate the quality, e.g., (poor, medium, good); where QoE metrics is a subset of QoE metrics data guaranteed for UE, e.g., Round-trip time, Jitter duration, Corruption duration, Throughput, Initial playout delay for video, video resolution, buffer occupancy level, etc.
Inference MDT data requirement: This info is used to request inference MDT information that is available at NG-RAN node 2.

This information may contain an indication for the inference MDT info requirement. In this case, NG-RAN node 2 may provide all inference MDT data that fulfills the requirement in this message.

This information may contain detailed MDT parameters/metrics. In this case, NG-RAN node 2 may provide all inference MDT data on the specific parameters/metrics that fulfills the requirement in this message. At least one of the following parameters/metrics may be included in this message.
Inference MDT requirement indication: This is used to indicate that NG-RAN node 2 needs to provide the inference MDT data.
M1: DL signal quantities measurement results for the serving cell and for intra-frequency/Inter-frequency/inter-RAT neighbor cells, including cell/beam level measurement for NR cells only.
M2: Power Headroom measurement by UE.
M3: Received Interference Power measurement.
M4: Data Volume measurement separately for DL and UL, per DRB per UE.
M5: Average UE throughout measurement separately for DL and UL, per DRB per UE and per UE for the DL, per DRB per UE and per UE for the UL, by gNB.
M6: Packet Delay measurement separately for DL and UL, per DRB per UE.
M7: Packet loss rate measurement separately for DL and UL, per DRB per UE.
M8: RSSI measurement by UE (for WLAN/Bluetooth measurement).
M9: RTT Measurement by UE (for WLAN measurement).
Confidence requirement of the inference data: This is an information element with the value from 0 to 100 (or may be a ratio). It is used to mark the level of trust/accuracy the inference data should be. NG-RAN node 2 can only provide the inference data if the confidence of this inference data is not lower than this threshold. Each inference data type (QoE, QoS, MDT) may has one related confidence requirement. In other alternative, one confidence info may be used to limit all inference data in this message.

### Time Related Information.

Time information of the needed data: NG-RAN node 1 may request NG-RAN node 2 to provide a chunk of data in a certain duration (or start & end time) for specific UE(s).
Reporting frequency: NG-RAN node 2 may transmit the needed data for specific UE(s) to NG-RAN node 1 periodically.

The time related info may co-exist in the message. If so, NG-RAN node 2 shall send a chunk of data that fulfills the duration limitation in “Time information of the needed data” in the first response message. Then NG-RAN node 2 may send the rest of stored data or newly generated data to NG-RAN node 2 by using configured “reporting frequency.”
Step 9: Based on the received requirement in step 8, NG-RAN node 2 may transmit the history data for AI function to NG-RAN node 1. At least one of the following info may be contained in the message.
UE ID(s): one or multiple UE IDs that is used to uniquely mark a UE. NG-RAN node 2 only needs to provide the history data for the specific UE(s).
Empty indicator: This optional indicator will be sent to NG-RAN node 1 if there is no available info at NG-RAN node 1 side.

History QoE data, history QoS data, and history MDT data will be added in this message if available. Detailed parameters/metrics of this data can be found in step 8.

Inference QoE data, inference QoS data, and inference MDT data will be added in this message if available. Detailed parameters/metrics of this data can be found in step 8.
Confidence information of the inference data: This is an information element with the value from 0 to 100 (or may be a ratio) that is generated by NG-RAN node 2. It is used to mark the level of trust/accuracy the inference data should be. Each inference data type (QoE, QoS, MDT) may have one related confidence information. In another alternative, one confidence info may be used to mark all inference data in this message.
Time information of the history data: The time information of the provided data.
Step 9a: If the history data is oversized or needs to be transmitted periodically, more than one message will be used for history data transmission. At least one of the following info may be contained in the message.
UE ID(s): one or multiple UE IDs that is used to uniquely mark a UE. NG-RAN node 2 only needs to provide the history data for the specific UE(s).
Empty indicator: This optional indicator will be sent to NG-RAN node 1 if there is no available info at NG-RAN node 1 side.

History QoE data, and/or history QoS data, and/or history MDT data will be added in this message if available. Detailed parameters/metrics of this data can be found in step 8.

Inference QoE data, and/or inference QoS data, and/or inference MDT data will be added in this message if available. Detailed parameters/metrics of this data can be found in step 8.
Confidence information of the inference data: This is an information element with the value from 0 to 100 (or may be a ratio) that is generated by NG-RAN node 2. It is used to mark the level of trust/accuracy the inference data should be. Each inference data type (QoE, QoS, MDT) may have one related confidence information. In another alternative, one confidence info may be used to mark all inference data in this message.
Time information of the history data: The time information of the provided data.
Step 10: After collecting enough data, NG-RAN node 1 may perform the AI model inference progress with enabled AI/ML function. The predicted QoE data and/or predicted QoS configuration and/or MDT data for specific UE(s) for next following timing(s) will be generated by NG-RAN node 1.

This step may be reflected in the 3GPP specifications as stage 2 description.
Step 11: After model inference, NG-RAN node 1 may trigger the inference action procedure. With the assistance of the inference/predicted QoE, QoS data, the NG-RAN node 1 may perform some processes not limited to the following ones.

NG-RAN node 1 may re-allocate the 3GPP/non-3GPP resources for each UE in this NG-RAN node.

NG-RAN node 1 may update the mobility strategy of the specific UE(s).

NG-RAN node 1 may send inference/predicted data to other NG-RAN nodes for inference procedure.

NG-RAN node 1 may send the inference/predicted data to NG-RAN node 2 for further QoS/QoE configuration, etc.

This step may be reflected in the 3GPP specifications as stage 2 description.
Step 12: Detailed description of the feedback procedure can be found in embodiment 5.

### IV. EMBODIMENT 3

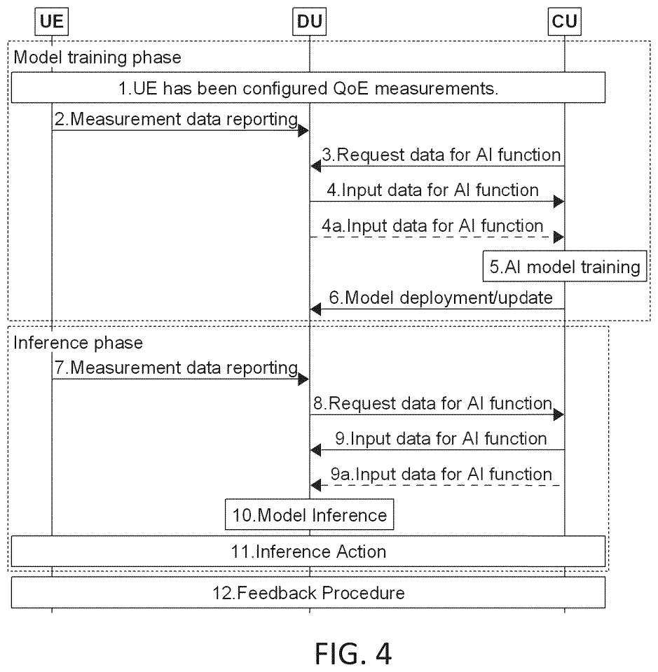

As shown in FIG. 4, Embodiment 3 illustrates AI training by a central unit (CU) and AI inference by a distributed unit (DU).

The involved procedure between DU and CU is F1 Application Protocol (F1AP) enhancement.

Before this procedure happens, all involved network entities may have been deployed with the AI model. So that the CU and DU may provide the inference data when they receive the data requirement in step 3/8.
Step 1: UE has been configured QoE measurements and is performing QoE data collection.
Step 2: UE transmits the measurement reports to DU periodically.
Step 3: CU sends message to DU and to request data for AI function (e.g., model training). At least one of the following information may be contained in this message.
UE ID(s): one or multiple UE IDs that is used to uniquely mark a UE. DU only needs to provide the history data for the specific UE(s).
Processing indicator: This indication is used to notice DU that the required info may be used for online training and/or inference. The DU may provide different amount of data based on this indication.
History QoS configuration requirement information: This info is used to request history QoS configuration information that is stored/available in DU.

This information may contain an indication for the history QoS configuration requirement. In this case, DU may provide all history QoS configuration that fulfills the requirement in this message.

This information may contain detailed QoS configuration parameters. In this case, DU may provide all history QoS configuration on the specific parameters that fulfills the requirement in this message. At least one of the following parameters may be included in this message.

History QoS configuration requirement indication, 5QI reference or QoS level identifier, Service Type, Packet Delay range, maximum Packet Delay, minimum Packet Delay, average Packet Delay, Packet Error Rate range, maximum Packet Error Rate, minimum Packet Error Rate, average Packet Error Rate, Packet Loss Rate range, maximum Packet Loss Rate, minimum Packet Loss Rate, average Packet Loss Rate, Guaranteed Flow Bit Rate range, maximum Guaranteed Flow Bit Rate, minimum Guaranteed Flow Bit Rate, average Guaranteed Flow Bit Rate.
History QoE (RVQoE) requirement information: This info is used to request history QoE information that is available at DU.

This information may contain an indication for the history QoE requirement. In this case, DU may provide all history QoE data that fulfills the requirement in this message.

This information may contain detailed QoE parameters/metrics. In this case, DU may provide all history QoE data on the specific parameters/metrics that fulfills the requirement in this message. At least one of the following parameters/metrics may be included in this message.

History QoE requirement indication, QoE level identifier, service type, area scope, QoE type (signaling based QoE, management based QoE), RAN visible QoE data, QoE report container, Codec rate, QoE Score, QoE metrics range, maximum QoE metrics, minimum QoE metrics, average QoE metrics, where QoE score could be a number range, e.g., 0 to 10, where 10 represents excellent quality and 0 represents poor quality; or QoE score could be an enumerated type to indicate the quality, e.g., (poor, medium, good); where QoE metrics is a subset of QoE metrics data guaranteed for UE, e.g., Round-trip time, Jitter duration, Corruption duration, Throughput, Initial playout delay for video, video resolution, buffer occupancy level, etc.
History MDT info requirement information: This info is used to request history MDT information that is available at DU.

This information may contain an indication for the history MDT info requirement. In this case, DU may provide all history MDT data that fulfills the requirement in this message.

This information may contain detailed MDT parameters/metrics. In this case, DU may provide all history MDT data on the specific parameters/metrics that fulfills the requirement in this message. At least one of the following parameters/metrics may be included in this message.
M1: DL signal quantities measurement results for the serving cell and for intra-frequency/Inter-frequency/inter-RAT neighbor cells, including cell/beam level measurement for NR cells only.
M2: Power Headroom measurement by UE.
M3: Received Interference Power measurement.
M4: Data Volume measurement separately for DL and UL, per DRB per UE.
M5: Average UE throughout measurement separately for DL and UL, per DRB per UE and per UE for the DL, per DRB per UE and per UE for the UL, by gNB.
M6: Packet Delay measurement separately for DL and UL, per DRB per UE.
M7: Packet loss rate measurement separately for DL and UL, per DRB per UE.
M8: RSSI measurement by UE (for WLAN/Bluetooth measurement).
M9: RTT Measurement by UE (for WLAN measurement).
Inference QoS data requirement: This info is used to request inference QoS information that is available at DU.

This information may contain an indication for the inference QoS configuration requirement. In this case, DU may provide all inference QoS configuration that fulfills the requirement in this message.

This information may contain detail QoS configuration parameters. In this case, DU may provide all inference QoS configuration on the specific parameters that fulfills the requirement in this message. At least one of the following parameters may be included in this message.
Inference QoS configuration requirement indication: This is used to indicate that DU needs to provide the inference QoS data.

5QI reference or QoS level identifier, Service Type, Packet Delay range, maximum Packet Delay, minimum Packet Delay, average Packet Delay, Packet Error Rate range, maximum Packet Error Rate, minimum Packet Error Rate, average Packet Error Rate, Packet Loss Rate range, maximum Packet Loss Rate, minimum Packet Loss Rate, average Packet Loss Rate, Guaranteed Flow Bit Rate range, maximum Guaranteed Flow Bit Rate, minimum Guaranteed Flow Bit Rate, average Guaranteed Flow Bit Rate.
Inference QoE data requirement: This info is used to request inference QoE information that is available at DU. The

This information may contain an indication for the inference QoE requirement. In this case, DU may provide all inference QoE data that fulfills the requirement in this message.

This information may contain detail QoE parameters/metrics. In this case, DU may provide all inference QoE data on the specific parameters/metrics that fulfills the requirement in this message. At least one of the following parameters/metrics may be included in this message.
Inference QoE requirement indication: This is used to indicate that DU needs to provide the inference QoE data.

QoE level identifier, service type, area scope, QoE type (signaling based QoE, management based QoE), RAN visible QoE data, QoE report container, Codec rate, QoE Score, QoE metrics range, maximum QoE metrics, minimum QoE metrics, average QoE metrics, where QoE score could be a number range, e.g., 0 to 10, where 10 represents excellent quality and 0 represents poor quality; or QoE score could be a enumerated type to indicate the quality, e.g., (poor, medium, good); where QoE metrics is a subset of QoE metrics data guaranteed for UE, e.g., Round-trip time, Jitter duration, Corruption duration, Throughput, Initial playout delay for video, video resolution, buffer occupancy level, etc.
Inference MDT data requirement: This info is used to request inference MDT information that is available at DU.

This information may contain an indication for the inference MDT info requirement. In this case, DU may provide all inference MDT data that fulfills the requirement in this message.

This information may contain detailed MDT parameters/metrics. In this case, DU may provide all inference MDT data on the specific parameters/metrics that fulfills the requirement in this message. At least one of the following parameters/metrics may be included in this message.
Inference MDT requirement indication: This is used to indicate that DU needs to provide the inference MDT data.
M1: DL signal quantities measurement results for the serving cell and for intra-frequency/Inter-frequency/inter-RAT neighbor cells, including cell/beam level measurement for NR cells only.
M2: Power Headroom measurement by UE.
M3: Received Interference Power measurement.
M4: Data Volume measurement separately for DL and UL, per DRB per UE.
M5: Average UE throughout measurement separately for DL and UL, per DRB per UE and per UE for the DL, per DRB per UE and per UE for the UL, by gNB.
M6: Packet Delay measurement separately for DL and UL, per DRB per UE.
M7: Packet loss rate measurement separately for DL and UL, per DRB per UE.
M8: RSSI measurement by UE (for WLAN/Bluetooth measurement).
M9: RTT Measurement by UE (for WLAN measurement).
Confidence requirement of the inference data: This is an information element with the value from 0 to 100 (or may be a ratio). It is used to mark the level of trust/accuracy the inference data should be. DU can only provide the inference data if the confidence of this inference data is not lower than this threshold. Each inference data type (QoE, QoS, MDT) may have one related confidence requirement. In another alternative, one confidence info may be used to limit all inference data in this message.

### Time Related Information.

Time information of the needed data: CU may request DU to provide a chunk of data in a certain duration (or start & end time) for specific UE(s).
Reporting frequency: DU may transmit the needed data for specific UE(s) to CU periodically.

The time related info may co-exist in the message. If so, NG-RAN node shall send a chunk of data that fulfills the duration limitation in “Time information of the needed data” in the first response message. Then DU may send the rest of stored data or newly generated data to CU by using configured “reporting frequency.”
Step 4: Based on the received requirement in step 3, DU may transmit the history data for AI function to CU. At least one of the following info may be contained in the message.
UE ID(s): one or multiple UE IDs that is used to uniquely mark a UE. DU only needs to provide the history data for the specific UE(s).
Empty indicator: This optional indicator will be sent to CU if there is no available info at DU side.

History QoE data, history QoS data, and history MDT data will be added in this message if available. Detailed parameters/metrics of this data can be found in step 3.

Inference QoE data, inference QoS data, and inference MDT data will be added in this message if available. Detailed parameters/metrics of this data can be found in step 3.
Confidence information of the inference data: This is an information element with the value from 0 to 100 (or may be a ratio) that is generated by DU. It is used to mark the level of trust/accuracy the inference data should be. Each inference data type (QoE, QoS, MDT) may have one related confidence information. In another alternative, one confidence info may be used to mark all inference data in this message.
Time information of the data: The time information of the provided data. It may be start & end time, duration.
Step 4a: If the data is oversized or needs to be transmitted periodically, multiple messages will be used for data transmission. At least one of the following info may be contained in the message.
UE ID(s): one or multiple UE IDs that is used to uniquely mark a UE. DU only needs to provide the history data for the specific UE(s).
Empty indicator: This optional indicator will be sent to CU if there is no available info at DU side.

History QoE data, and/or history QoS data, and/or history MDT data will be added in this message if available. Detailed parameters/metrics of this data can be found in step 3.

Inference QoE data, and/or inference QoS data, and/or inference MDT data will be added in this message if available. Detailed parameters/metrics of this data can be found in step 3.
Confidence information of the inference data: This is an information element with the value from 0 to 100 (or may be a ratio) that is generated by DU. It is used to mark the level of trust/accuracy the inference data should be. Each inference data type (QoE, QoS, MDT) may have one related confidence information. In another alternative, one confidence info may be used to mark all inference data in this message.
Time information of the data: The time information of the provided data. It may be start & end time, duration.
Step 5: After collecting enough data, CU may perform the AI model training progress with enabled AI/ML function.

This step may be reflected in the 3GPP specifications as stage 2 description.
Step 6: After CU generates the AI model, the new model will be deployed/updated to the DU.
Step 7: UE keeps sending measurement data to DU (if any).
Step 8: DU sends message to CU and to request data for AI function (e.g., model inference). At least one of the following information may be contained in this message.
UE ID(s): one or multiple UE IDs that is used to uniquely mark a UE. CU only needs to provide the history data for the specific UE(s).
Processing indicator: This indication is used to notice CU that the required info may be used for online training and/or inference. The CU may provide different amount of data based on this indication.
History QoS configuration requirement information: This info is used to request history QoS configuration information that is stored/available in CU.

This information may contain an indication for the history QoS configuration requirement. In this case, DU may provide all history QoS configuration that fulfills the requirement in this message.

This information may contain detailed QoS configuration parameters. In this case, CU may provide all history QoS configuration on the specific parameters that fulfills the requirement in this message. At least one of the following parameters may be included in this message.

History QoS configuration requirement indication, 5QI reference or QoS level identifier, Service Type, Packet Delay range, maximum Packet Delay, minimum Packet Delay, average Packet Delay, Packet Error Rate range, maximum Packet Error Rate, minimum Packet Error Rate, average Packet Error Rate, Packet Loss Rate range, maximum Packet Loss Rate, minimum Packet Loss Rate, average Packet Loss Rate, Guaranteed Flow Bit Rate range, maximum Guaranteed Flow Bit Rate, minimum Guaranteed Flow Bit Rate, average Guaranteed Flow Bit Rate.
History QoE (RVQoE) requirement information: This info is used to request history QoE information that is available at CU.

This information may contain an indication for the history QoE requirement. In this case, CU may provide all history QoE data that fulfills the requirement in this message.

This information may contain detailed QoE parameters/metrics. In this case, CU may provide all history QoE data on the specific parameters/metrics that fulfills the requirement in this message. At least one of the following parameters/metrics may be included in this message.

History QoE requirement indication, QoE level identifier, service type, area scope, QoE type (signaling based QoE, management based QoE), RAN visible QoE data, QoE report container, Codec rate, QoE Score, QoE metrics range, maximum QoE metrics, minimum QoE metrics, average QoE metrics, where QoE score could be a number range, e.g., 0 to 10, where 10 represents excellent quality and 0 represents poor quality; or QoE score could be a enumerated type to indicate the quality, e.g., (poor, medium, good); where QoE metrics is a subset of QoE metrics data guaranteed for UE, e.g., Round-trip time, Jitter duration, Corruption duration, Throughput, Initial playout delay for video, video resolution, buffer occupancy level, etc.
History MDT info requirement information: This info is used to request history MDT information that is available at CU.

This information may contain an indication for the history MDT info requirement. In this case, CU may provide all history MDT data that fulfills the requirement in this message.

This information may contain detailed MDT parameters/metrics. In this case, CU may provide all history MDT data on the specific parameters/metrics that fulfills the requirement in this message. At least one of the following parameters/metrics may be included in this message.
M1: DL signal quantities measurement results for the serving cell and for intra-frequency/Inter-frequency/inter-RAT neighbor cells, including cell/beam level measurement for NR cells only.
M2: Power Headroom measurement by UE.
M3: Received Interference Power measurement.
M4: Data Volume measurement separately for DL and UL, per DRB per UE.
M5: Average UE throughout measurement separately for DL and UL, per DRB per UE and per UE for the DL, per DRB per UE and per UE for the UL, by gNB.
M6: Packet Delay measurement separately for DL and UL, per DRB per UE.
M7: Packet loss rate measurement separately for DL and UL, per DRB per UE.
M8: RSSI measurement by UE (for WLAN/Bluetooth measurement).
M9: RTT Measurement by UE (for WLAN measurement).
Inference QoS data requirement: This info is used to request inference QoS information that is available at CU.

This information may contain an indication for the inference QoS configuration requirement. In this case, CU may provide all inference QoS configuration that fulfills the requirement in this message.

This information may contain detailed QoS configuration parameters. In this case, CU may provide all inference QoS configuration on the specific parameters that fulfills the requirement in this message. At least one of the following parameters may be included in this message.
Inference QoS configuration requirement indication: This is used to indicate that CU needs to provide the inference QoS data.

5QI reference or QoS level identifier, Service Type, Packet Delay range, maximum Packet Delay, minimum Packet Delay, average Packet Delay, Packet Error Rate range, maximum Packet Error Rate, minimum Packet Error Rate, average Packet Error Rate, Packet Loss Rate range, maximum Packet Loss Rate, minimum Packet Loss Rate, average Packet Loss Rate, Guaranteed Flow Bit Rate range, maximum Guaranteed Flow Bit Rate, minimum Guaranteed Flow Bit Rate, average Guaranteed Flow Bit Rate.
Inference QoE data requirement: This info is used to request inference QoE information that is available at CU. The

This information may contain an indication for the inference QoE requirement. In this case, CU may provide all inference QoE data that fulfills the requirement in this message.

This information may contain detailed QoE parameters/metrics. In this case, CU may provide all inference QoE data on the specific parameters/metrics that fulfills the requirement in this message. At least one of the following parameters/metrics may be included in this message.
Inference QoE requirement indication: This is used to indicate that DU needs to provide the inference QoE data.

Start time and end time of this inference data or the duration of this inference data.

QoE level identifier, service type, area scope, QoE type (signaling based QoE, management based QoE), RAN visible QoE data, QoE report container, Codec rate, QoE Score, QoE metrics range, maximum QoE metrics, minimum QoE metrics, average QoE metrics, where QoE score could be a number range, e.g., 0 to 10, where 10 represents excellent quality and 0 represents poor quality; or QoE score could be an enumerated type to indicate the quality, e.g., (poor, medium, good); where QoE metrics is a subset of QoE metrics data guaranteed for UE, e.g., Round-trip time, Jitter duration, Corruption duration, Throughput, Initial playout delay for video, video resolution, buffer occupancy level, etc.
Inference MDT data requirement: This info is used to request inference MDT information that is available at CU.

This information may contain an indication for the inference MDT info requirement. In this case, CU may provide all inference MDT data that fulfills the requirement in this message.

This information may contain detailed MDT parameters/metrics. In this case, CU may provide all inference MDT data on the specific parameters/metrics that fulfills the requirement in this message. At least one of the following parameters/metrics may be included in this message.
Inference MDT requirement indication: This is used to indicate that DU needs to provide the inference MDT data.
M1: DL signal quantities measurement results for the serving cell and for intra-frequency/Inter-frequency/inter-RAT neighbor cells, including cell/beam level measurement for NR cells only.
M2: Power Headroom measurement by UE.
M3: Received Interference Power measurement.
M4: Data Volume measurement separately for DL and UL, per DRB per UE.
M5: Average UE throughout measurement separately for DL and UL, per DRB per UE and per UE for the DL, per DRB per UE and per UE for the UL, by gNB.
M6: Packet Delay measurement separately for DL and UL, per DRB per UE.
M7: Packet loss rate measurement separately for DL and UL, per DRB per UE.
M8: RSSI measurement by UE (for WLAN/Bluetooth measurement).
M9: RTT Measurement by UE (for WLAN measurement).
Confidence requirement of the inference data: This is an information element with the value from 0 to 100 (or may be a ratio). It is used to mark the level of trust/accuracy the inference data should be. CU can only provide the inference data if the confidence of this inference data is not lower than this threshold. Each inference data type (QoE, QoS, MDT) may have one related confidence requirement. In another alternative, one confidence info may be used to limit all inference data in this message.

### Time Related Information.

Time information of the needed data: DU may request CU to provide a chunk of data in a certain duration (or start & end time) for specific UE(s).
Reporting frequency: CU may transmit the needed data for specific UE(s) to DU periodically.

The time related info may co-exist in the message. If so, CU shall send a chunk of data that fulfills the duration limitation in “Time information of the needed data” in the first response message. Then CU may send the rest of stored data or newly generated data to DU by using configured “reporting frequency.”
Feedback request indication: This indication is used for DU to ask for feedback of the inference. With this indication, after CU receives the inference data from DU, it shall send the feedback info to DU if available.
Step 9: Based on the received requirement in step 8, CU may transmit the required data for AI function to DU. At least one of the following info may be contained in the message.
UE ID(s): one or multiple UE IDs that is used to uniquely mark a UE. CU only needs to provide the history data for the specific UE(s).
Empty indicator: This optional indicator will be sent to DU if there is no available info at CU side.

History QoE data, history QoS data, and history MDT data will be added in this message if available. Detailed parameters/metrics of this data can be found in step 8.

Inference QoE data, inference QoS data, and inference MDT data will be added in this message if available. Detailed parameters/metrics of this data can be found in step 8.
Confidence information of the inference data: This is an information element with the value from 0 to 100 (or may be a ratio) that is generated by CU. It is used to mark the level of trust/accuracy the inference data should be. Each inference data type (QoE, QoS, MDT) may have one related confidence information. In another alternative, one confidence info may be used to mark all inference data in this message.
Time information of the history data: The time information of the provided data.
Step 9a: If the history data is oversized or needs to be transmitted periodically, more than one message will be used for history data transmission. At least one of the following info may be contained in the message.
UE ID(s): one or multiple UE IDs that is used to uniquely mark a UE. CU only needs to provide the history data for the specific UE(s).
Empty indicator: This optional indicator will be sent to DU if there is no available info at CU side.

History QoE data, history QoS data, and history MDT data will be added in this message if available. Detailed parameters/metrics of this data can be found in step 8.

Inference QoE data, inference QoS data, and inference MDT data will be added in this message if available. Detailed parameters/metrics of this data can be found in step 8.
Confidence information of the inference data: This is an information element with the value from 0 to 100 (or may be a ratio) that is generated by CU. It is used to mark the level of trust/accuracy the inference data should be. Each inference data type (QoE, QoS, MDT) may have one related confidence information. In another alternative, one confidence info may be used to mark all inference data in this message.
Time information of the history data: The time information of the provided data.
Step 10: After collecting enough data, DU may perform the AI model inference progress with enabled AI/ML function. The predicted QoE data and/or predicted QoS configuration and/or predicted MDT data for specific UE(s) for next following timing(s) will be generated by DU.

This step may be reflected in the 3GPP specifications as stage 2 description.
Step 11: After model inference, DU may trigger the inference action procedure. With the assistance of the inference/predicted QoE, QoS data, the DU may perform some processes not limited to the following ones.

DU may re-schedule the 3GPP/non-3GPP resources for UEs based on the received inference data.

DU may send the QoS/RB modification requirement to the CU based on the evaluation of the received inference data, etc.

This step may be reflected in the 3GPP specifications as stage 2 description.
Step 12: Detail description of the feedback procedure can be found in embodiment 5.

### V. EMBODIMENT 4

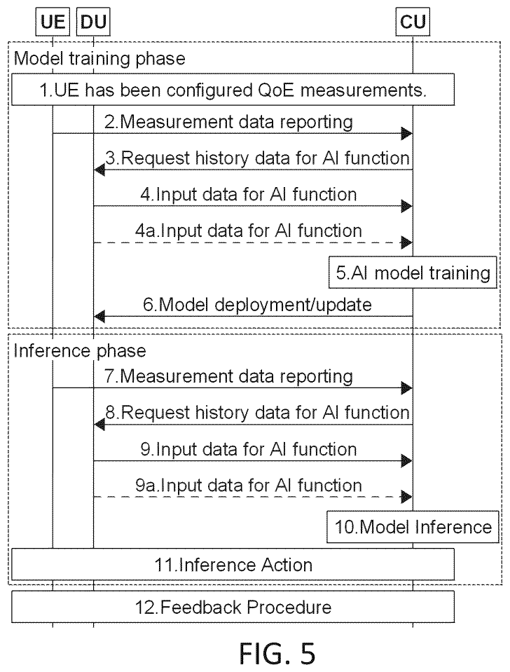

As shown in FIG. 5, Embodiment 4 illustrates AI training and inference by a central unit (CU).

The involved procedure between DU and CU is F1AP enhancement.

Before this procedure happens, all involved network entities may have been deployed with the AI model. So that the CU and DU may provide the inference data when they receive the data requirement in step 3/8.
Step 1: UE has been configured QoE measurements and is performing QoE data collection.
Step 2: UE transmits the measurement reports to DU periodically.
Step 3, 4, 4a, and 5 are the same as the ones in embodiment 3.
Step 6: CU may send the updated AI model to DU.

In this embodiment, CU also use the updated AI model locally.
Step 7: UE keeps sending measurement data to DU (if any).
Step 8: CU sends message to DU and to request data for AI function (e.g., model inference). At least one of the following information may be contained in this message.
UE ID(s): one or multiple UE IDs that is used to uniquely mark a UE. DU only needs to provide the history data for the specific UE(s).
Processing indicator: This indication is used to notice DU that the required info may be used for online training and/or inference. The DU may provide different amount of data based on this indication.
History QoS configuration requirement information: This info is used to request history QoS configuration information that is stored/available in DU.

This information may contain an indication for the history QoS configuration requirement. In this case, DU may provide all history QoS configuration that fulfills the requirement in this message.

This information may contain detailed QoS configuration parameters. In this case, DU may provide all history QoS configuration on the specific parameters that fulfills the requirement in this message. At least one of the following parameters may be included in this message.

History QoS configuration requirement indication, 5QI reference or QoS level identifier, Service Type, Packet Delay range, maximum Packet Delay, minimum Packet Delay, average Packet Delay, Packet Error Rate range, maximum Packet Error Rate, minimum Packet Error Rate, average Packet Error Rate, Packet Loss Rate range, maximum Packet Loss Rate, minimum Packet Loss Rate, average Packet Loss Rate, Guaranteed Flow Bit Rate range, maximum Guaranteed Flow Bit Rate, minimum Guaranteed Flow Bit Rate, average Guaranteed Flow Bit Rate.
History QoE (RVQoE) requirement information: This info is used to request history QoE information that is available at DU.

This information may contain an indication for the history QoE requirement. In this case, DU may provide all history QoE data that fulfills the requirement in this message.

This information may contain detailed QoE parameters/metrics. In this case, DU may provide all history QoE data on the specific parameters/metrics that fulfills the requirement in this message. At least one of the following parameters/metrics may be included in this message.

History QoE requirement indication, QoE level identifier, service type, area scope, QoE type (signaling based QoE, management based QoE), RAN visible QoE data, QoE report container, Codec rate, QoE Score, QoE metrics range, maximum QoE metrics, minimum QoE metrics, average QoE metrics, where QoE score could be a number range, e.g., 0 to 10, where 10 represents excellent quality and 0 represents poor quality; or QoE score could be an enumerated type to indicate the quality, e.g., (poor, medium, good); where QoE metrics is a subset of QoE metrics data guaranteed for UE, e.g., Round-trip time, Jitter duration, Corruption duration, Throughput, Initial playout delay for video, video resolution, buffer occupancy level, etc.
History MDT info requirement information: This info is used to request history MDT information that is available at DU.

This information may contain an indication for the history MDT info requirement. In this case, DU may provide all history MDT data that fulfills the requirement in this message.

This information may contain detailed MDT parameters/metrics. In this case, DU may provide all history MDT data on the specific parameters/metrics that fulfills the requirement in this message. At least one of the following parameters/metrics may be included in this message.
M1: DL signal quantities measurement results for the serving cell and for intra-frequency/Inter-frequency/inter-RAT neighbor cells, including cell/beam level measurement for NR cells only.
M2: Power Headroom measurement by UE.
M3: Received Interference Power measurement.
M4: Data Volume measurement separately for DL and UL, per DRB per UE.
M5: Average UE throughout measurement separately for DL and UL, per DRB per UE and per UE for the DL, per DRB per UE and per UE for the UL, by gNB.
M6: Packet Delay measurement separately for DL and UL, per DRB per UE.
M7: Packet loss rate measurement separately for DL and UL, per DRB per UE.
M8: RSSI measurement by UE (for WLAN/Bluetooth measurement).
M9: RTT Measurement by UE (for WLAN measurement).
Inference QoS data requirement: This info is used to request inference QoS information that is available at DU.

This information may contain an indication for the inference QoS configuration requirement. In this case, DU may provide all inference QoS configuration that fulfills the requirement in this message.

This information may contain detailed QoS configuration parameters. In this case, DU may provide all inference QoS configuration on the specific parameters that fulfills the requirement in this message. At least one of the following parameters may be included in this message.
Inference QoS configuration requirement indication: This is used to indicate that DU needs to provide the inference QoS data.

5QI reference or QoS level identifier, Service Type, Packet Delay range, maximum Packet Delay, minimum Packet Delay, average Packet Delay, Packet Error Rate range, maximum Packet Error Rate, minimum Packet Error Rate, average Packet Error Rate, Packet Loss Rate range, maximum Packet Loss Rate, minimum Packet Loss Rate, average Packet Loss Rate, Guaranteed Flow Bit Rate range, maximum Guaranteed Flow Bit Rate, minimum Guaranteed Flow Bit Rate, average Guaranteed Flow Bit Rate.
Inference QoE data requirement: This info is used to request inference QoE information that is available at DU. The

This information may contain an indication for the inference QoE requirement. In this case, DU may provide all inference QoE data that fulfills the requirement in this message.

This information may contain detail QoE parameters/metrics. In this case, DU may provide all inference QoE data on the specific parameters/metrics that fulfills the requirement in this message. At least one of the following parameters/metrics may be included in this message.
Inference QoE requirement indication: This is used to indicate that DU needs to provide the inference QoE data.

Start time and end time of this inference data or the duration of this inference data.

QoE level identifier, service type, area scope, QoE type (signaling based QoE, management based QoE), RAN visible QoE data, QoE report container, Codec rate, QoE Score, QoE metrics range, maximum QoE metrics, minimum QoE metrics, average QoE metrics, where QoE score could be a number range, e.g., 0 to 10, where 10 represents excellent quality and 0 represents poor quality; or QoE score could be a enumerated type to indicate the quality, e.g., (poor, medium, good); where QoE metrics is a subset of QoE metrics data guaranteed for UE, e.g., Round-trip time, Jitter duration, Corruption duration, Throughput, Initial playout delay for video, video resolution, buffer occupancy level, etc.
Inference MDT data requirement: This info is used to request inference MDT information that is available at DU.

This information may contain an indication for the inference MDT info requirement. In this case, DU may provide all inference MDT data that fulfills the requirement in this message.

This information may contain detailed MDT parameters/metrics. In this case, DU may provide all inference MDT data on the specific parameters/metrics that fulfills the requirement in this message. At least one of the following parameters/metrics may be included in this message.
Inference MDT requirement indication: This is used to indicate that DU needs to provide the inference MDT data.
M1: DL signal quantities measurement results for the serving cell and for intra-frequency/Inter-frequency/inter-RAT neighbor cells, including cell/beam level measurement for NR cells only.
M2: Power Headroom measurement by UE.
M3: Received Interference Power measurement.
M4: Data Volume measurement separately for DL and UL, per DRB per UE.
M5: Average UE throughout measurement separately for DL and UL, per DRB per UE and per UE for the DL, per DRB per UE and per UE for the UL, by gNB.
M6: Packet Delay measurement separately for DL and UL, per DRB per UE.
M7: Packet loss rate measurement separately for DL and UL, per DRB per UE.
M8: RSSI measurement by UE (for WLAN/Bluetooth measurement).
M9: RTT Measurement by UE (for WLAN measurement).
Confidence requirement of the inference data: This is an information element with the value from 0 to 100 (or may be a ratio). It is used to mark the level of trust/accuracy the inference data should be. DU can only provide the inference data if the confidence of this inference data is not lower than this threshold. Each inference data type (QoE, QoS, MDT) may have one related confidence requirement. In another alternative, one confidence info may be used to limit all inference data in this message.

### Time Related Information.

Time information of the needed data: CU may request DU to provide a chunk of data in a certain duration (or start & end time) for specific UE(s).
Reporting frequency: DU may transmit the needed data for specific UE(s) to CU periodically.

The time related info may co-exist in the message. If so, DU shall send a chunk of data that fulfills the duration limitation in “Time information of the needed data” in the first response message. Then DU may send the rest of stored data or newly generated data to CU by using configured “reporting frequency.”
Feedback request indication: This indication is used for CU to ask for feedback of the inference. With this indication, after DU receives the inference data from CU, it shall send the feedback info to CU if available.
Step 9: Based on the received requirement in step 8, DU may transmit the required data for AI function to CU. At least one of the following info may be contained in the message.
UE ID(s): one or multiple UE IDs that is used to uniquely mark a UE. DU only needs to provide the history data for the specific UE(s).
Empty indicator: This optional indicator will be sent to CU if there is no available info at DU side.

History QoE data, history QoS data, and history MDT data will be added in this message if available. Detailed parameters/metrics of this data can be found in step 8.

Inference QoE data, inference QoS data, and inference MDT data will be added in this message if available. Detailed parameters/metrics of this data can be found in step 8.
Confidence information of the inference data: This is an information element with the value from 0 to 100 (or may be a ratio) that is generated by DU. It is used to mark the level of trust/accuracy the inference data should be. Each inference data type (QoE, QoS, MDT) may have one related confidence information. In another alternative, one confidence info may be used to mark all inference data in this message.
Time information of the history data: The time information of the provided data.
Step 9a: If the history data is oversized or needs to be transmitted periodically, more than one message will be used for history data transmission. At least one of the following info may be contained in the message.
UE ID(s): one or multiple UE IDs that is used to uniquely mark a UE. DU only needs to provide the history data for the specific UE(s).
Empty indicator: This optional indicator will be sent to CU if there is no available info at DU side.

History QoE data, and/or history QoS data, and/or history MDT data will be added in this message if available. Detailed parameters/metrics of this data can be found in step 8.

Inference QoE data, and/or inference QoS data, and/or inference MDT data will be added in this message if available. Detailed parameters/metrics of this data can be found in step 8.
Confidence information of the inference data: This is an information element with the value from 0 to 100 (or may be a ratio) that is generated by DU. It is used to mark the level of trust/accuracy the inference data should be. Each inference data type (QoE, QoS, MDT) may have one related confidence information. In another alternative, one confidence info may be used to mark all inference data in this message.
Time information of the history data: The time information of the provided data.
Step 10: After collecting enough data, CU may perform the AI model inference progress with enabled AI/ML function. The predicted QoE data and/or predicted QoS configuration and/or predicted MDT data for specific UE(s) for next following timing(s) will be generated by CU.

This step may be reflected in the 3GPP specifications as stage 2 description.
Step 11: After model inference, CU may trigger the inference action procedure. With the assistance of the inference/predicted QoE, QoS data, the CU may perform some processes not limited to the following ones.

CU may re-allocate the 3GPP/non-3GPP resources for each UE in this NG-RAN node.

CU may update the mobility strategy of the specific UE(s).

CU may send inference/predicted data to other network entities (e.g., DU, other NG-RAN nodes) for inference procedure.

CU may send the inference/predicted data to (e.g., DU, other NG-RAN nodes) for further QoS/QoE configuration, etc.

This step may be reflected in the 3GPP specifications as stage 2 description.
Step 12: Detail description of the feedback procedure can be found in embodiment 5.

### VI. EMBODIMENT 5

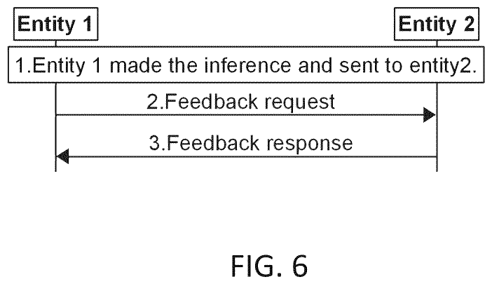

As shown in FIG. 6, Embodiment 5 illustrates a feedback procedure.
Step 1: Entity 1 made the inference and sent the inference data to entity 2.
[Optional] Step 2: Entity 1 may send a Feedback request message to entity 2. At least one of the following info may be contained in the message.
Feedback request indication: This indicates that the entity 2 needs to provide the feedback data for the received inference data.
UE ID: one or multiple UE that is used to uniquely identify the UE(s).
Timing information: This indicates that this feedback is reflected to the timing info for the inference data.
Feedback data type request: This indication is used for entity 1 to request specific feedback of one/multiple data type (e.g., QoS, QoE, MDT, etc.).
Feedback requirement: This indication is used for entity 1 to ask entity 2 to provide the feedback information for the inference data. At least one of the following info will be contained in this aspect.

The relationship level between two of the following info: QoE data, QoS configuration, MDT data. Detailed data type can be found in previous embodiments. How is the relationship level between two kinds of data may be presented by the value within the value range (0,100), (range 0 to 10), ratio, or “low, medium, high”, etc.
Accuracy level of the inference data. This may be presented by the value within range (0, 100), (range0, 10), ratio, or “low, medium, high”, “low, high”, etc.
Reflection of the QoE data. Is the QoE data better than the previous one before the AI/ML optimization?

This step may be defined by 3GPP. But without this message, entity 2 may also send the feedback message to entity 1 automatically.
Step 3: Entity 2 sends the response message to entity 1. At least one of the following info shall be contained in the message.
UE ID: one or multiple UE that is used to uniquely identify the UE(s).
Timing information: This indicates that this feedback is reflected to the timing info for the inference data.
UE QoS configuration list: This contains the UE real QoS configuration.
UE QoE information list: This contains the UE real QoE measurement data.
UE MDT information list: This contains the UE real MDT measurement data.
Feedback information: Detailed data on feedback depends on the requirement. At least one of the following info will be contained in this aspect.

The relationship level between two of the following info: QoE data, QoS configuration, MDT data. Detailed data type can be found in previous embodiments. How is the relationship level between two kinds of data may be presented by the value within the value range (0,100), (range 0 to 10), ratio, or “low, medium, high”, etc.
Accuracy level of the inference data. This may be presented by the value within range (0, 100), (range0, 10), ratio, or “low, medium, high”, “low, high”, etc.
Reflection of the QoE data. Is the QoE data better than the previous one before the AI/ML optimization?

2 kinds of feedback mechanisms may be used based on the procedure shown in this embodiment.

### Working Mode 1.

In this alternative, entity 2 may send the feedback data (e.g., UE QoS, QoE, MDT, Confidence, etc.) for one timing to entity 1.

### Working Mode 2.

In this alternative, entity 2 may send a list that contains one or multiple feedback data for different timings (e.g., UE QoS, QoE, MDT, timing, etc.) to entity 1. Based on the implementation or 3GPP definition, confidence can be used to reflect the inference data in this list. Or the inference data for each timing may link to confidence information.

Different enhancement may be needed for this embodiment.

If entities 1 and 2 are CN and RAN nodes, then the NGAP enhancement is needed.

If entities 1 and 2 are RAN nodes, then the XnAP enhancement is needed.

If entities 1 and 2 are CU and/or DU, then the F1AP enhancement is needed.

The input data consist of history data (QoE, QoS, MDT) and/or inference data (QoE, QoS, MDT). The input data can be used by the entity that is responsible for the AI/ML model function and is shown in the above embodiments for the AI model training and/or model inference. When the AI/ML entity receives the input data, it can send the input data to the AI/ML model function. With the assistance of the AI/ML model function, a new or updated AI/ML model function can be generated by this entity. In addition, with the assistance of the AI/ML model function, the inference data for different fields (e.g., QoE, QoS, MDT) can be generated based on the received input data.

By using the inference data (e.g., QoE, QoS, MDT), the entity (e.g., different entities in different embodiments) can reschedule the 3GPP/non-3GPP resources for a specific UE by considering both its current condition and the condition in the future. In addition, the entity may update the mobility strategy of this UE by considering its inference data and other inference data from neighboring nodes of this UE's serving node.

In addition, by receiving multiple UEs' inference data from the same/different entities, a network entity (e.g., CU, gNB) may optimize its local resources by considering the predicted situations for better power saving and efficiency.

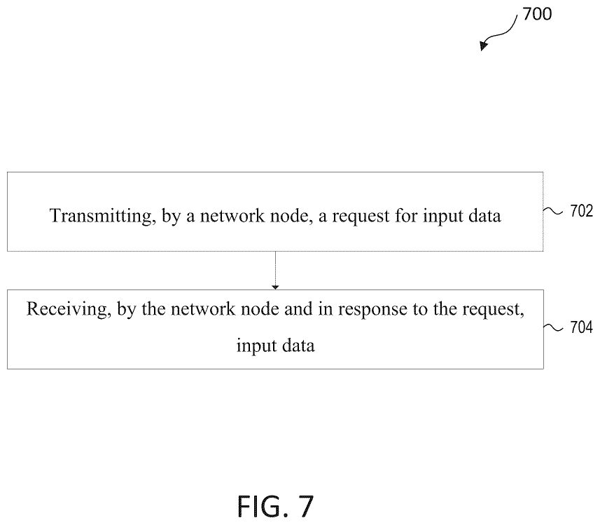

FIG. 7 is an exemplary flowchart for requesting input data. Operation 702 includes transmitting, by a network node, a request for input data. Operation 704 includes receiving, by the network node and in response to the request, input data. In some embodiments, the method can be implemented according to Embodiments 1-4. In some embodiments, performing further steps of the method can be based on a better system performance than a legacy protocol.

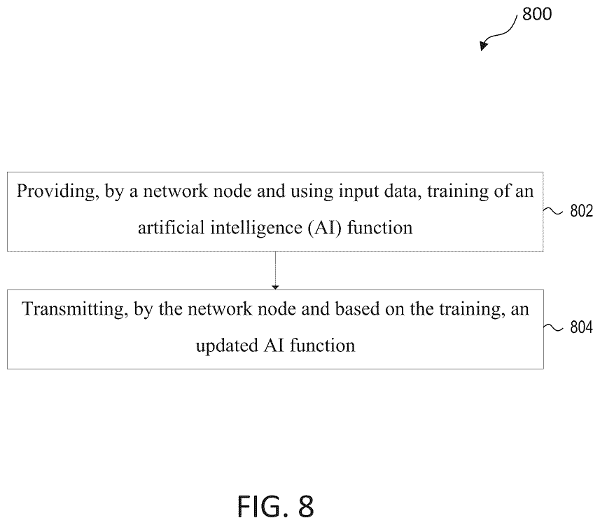

FIG. 8 is an exemplary flowchart for training an AI function. Operation 802 includes providing, by a network node and using input data, training of an artificial intelligence (AI) function. Operation 804 includes transmitting, by the network node and based on the training, an updated AI function. In some embodiments, the method can be implemented according to Embodiments 1-4. In some embodiments, performing further steps of the method can be based on a better system performance than a legacy protocol.

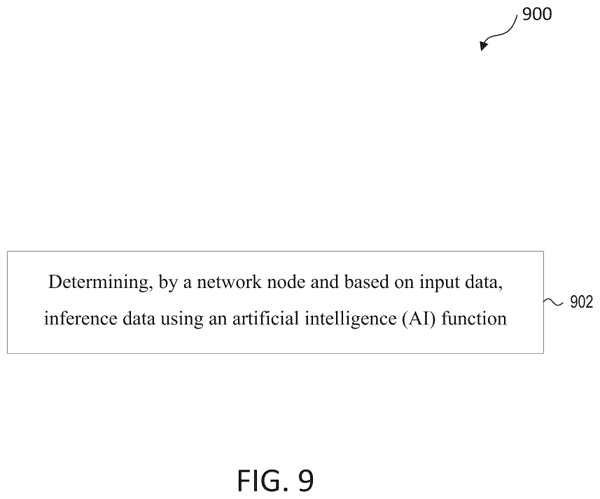

FIG. 9 is an exemplary flowchart for determining inference data. Operation 902 includes determining, by a network node and based on input data, inference data using an artificial intelligence (AI) function. In some embodiments, the method can be implemented according to Embodiments 1-4. In some embodiments, performing further steps of the method can be based on a better system performance than a legacy protocol.

In some embodiments, the network node is an operations, administration, and maintenance (OAM) node or a core network (CN) node, where transmitting the request includes transmitting the request to a radio access network (RAN) node, and where receiving the input data includes receiving the input data from the RAN node. In some embodiments, the network node is a first radio access network (RAN) node, where transmitting the request includes transmitting the request to a second RAN node, and where receiving the input data includes receiving the input data from the second RAN node. In some embodiments, the network node is a central unit (CU), where transmitting the request includes transmitting the request to a distributed unit (DU), and where receiving the input data includes receiving the input data from the DU. In some embodiments, the network node is a distributed unit (DU), where transmitting the request includes transmitting the request to a central unit (CU), and where receiving the input data includes receiving the input data from the CU.

In some embodiments, the request includes at least one of the following: a processing indicator, history quality of service (QoS) configuration requirement information, history quality of experience (QoE) data requirement information, history minimization of drive test (MDT) data requirement information, inference QoS configuration requirement information, inference QoE data requirement information, and inference MDT data requirement information.

In some embodiments, the history QoS configuration requirement information includes at least one of the following: a history QoS configuration requirement indication, a 5G QoS identifier (5QI) reference, a QoS level identifier, a service type, a packet delay range, a maximum packet delay, a minimum packet delay, an average packet delay, a packet error rate range, a maximum packet error rate, a minimum packet error rate, an average packet error rate, a packet loss rate range, a maximum packet loss rate, a minimum packet loss rate, an average packet loss rate, a guaranteed flow bit rate range, a maximum guaranteed flow bit rate, a minimum guaranteed flow bit rate, and an average guaranteed flow bit rate. In some embodiments, the history QoS configuration requirement indication includes a history QoS configuration requirement, where a first radio access network (RAN) node, a second RAN node, a central unit (CU), or a distributed unit (DU) provides all history QoS configurations that fulfill the history QoS configuration requirement.

In some embodiments, the history QoE data requirement information includes at least one of the following: a history QoE data requirement indication, a QoE level identifier, a service type, an area scope, a QoE type, radio access network (RAN) visible QoE data, a QoE report container, a codec rate, a QoE score, a QoE metric range, a maximum QoE metric, a minimum QoE metric, and an average QoE metric, where QoE metrics include at least one of the following: a round-trip time, a jitter duration, a corruption duration, a throughput, an initial playout delay for video, a video resolution, and a buffer occupancy level. In some embodiments, the history QoE data requirement indication includes a history QoE data requirement, where a first radio access network (RAN) node, a second RAN node, a central unit (CU), or a distributed unit (DU) provides all history QoE data that fulfill the history QoE data requirement.

In some embodiments, the history MDT data requirement information includes at least one of the following: a history MDT data requirement indication, a downlink (DL) signal quantity measurement result, a power headroom measurement by a user equipment (UE), a received interference power measurement, a data volume measurement, an average UE throughout measurement, a packet delay measurement, a packet loss rate measurement, a received signal strength indicator (RSSI) measurement, and a round trip time (RTT) measurement. In some embodiments, the history MDT data requirement indication includes a history MDT data requirement, where a first radio access network (RAN) node, a second RAN node, a central unit (CU), or a distributed unit (DU) provides all history MDT data that fulfill the history MDT data requirement.

In some embodiments, the inference QoS configuration requirement information includes at least one of the following: an inference QoS configuration requirement indication, a 5G QoS identifier (5QI) reference, a QoS level identifier, a service type, a packet delay range, a maximum packet delay, a minimum packet delay, an average packet delay, a packet error rate range, a maximum packet error rate, a minimum packet error rate, an average packet error rate, a packet loss rate range, a maximum packet loss rate, a minimum packet loss rate, an average packet loss rate, a guaranteed flow bit rate range, a maximum guaranteed flow bit rate, a minimum guaranteed flow bit rate, and an average guaranteed flow bit rate. In some embodiments, the inference QoS configuration requirement indication includes an inference QoS configuration requirement, where a first radio access network (RAN) node, a second RAN node, a central unit (CU), or a distributed unit (DU) provides all inference QoS configurations that fulfill the inference QoS configuration requirement.

In some embodiments, the inference QoE data requirement information includes at least one of the following: an inference QoE data requirement indication, a start time of inference QoE data, an end time of inference QoE data, a duration of inference QoE data, a QoE level identifier, a service type, an area scope, a QoE type, radio access network (RAN) visible QoE data, a QoE report container, a codec rate, a QoE score, a QoE metric range, a maximum QoE metric, a minimum QoE metric, and an average QoE metric, where QoE metrics include at least one of the following: a round-trip time, a jitter duration, a corruption duration, a throughput, an initial playout delay for video, a video resolution, and a buffer occupancy level. In some embodiments, the inference QoE data requirement indication includes an inference QoE data requirement, where a first radio access network (RAN) node, a second RAN node, a central unit (CU), or a distributed unit (DU) provides all inference QoE data that fulfill the inference QoE data requirement.

In some embodiments, the inference MDT data requirement information includes at least one of the following: an inference MDT data requirement indication, a downlink (DL) signal quantity measurement result, a power headroom measurement by a user equipment (UE), a received interference power measurement, a data volume measurement, an average UE throughout measurement, a packet delay measurement, a packet loss rate measurement, a received signal strength indicator (RSSI) measurement, and a round trip time (RTT) measurement. In some embodiments, the inference MDT data requirement indication includes an inference MDT data requirement, where a first radio access network (RAN) node, a second RAN node, a central unit (CU), or a distributed unit (DU) provides all inference MDT data that fulfill the inference MDT data requirement.

In some embodiments, the input data includes at least one of the following: history quality of service (QoS) data, history quality of experience (QoE) data, history minimization of drive test (MDT) data, inference QoS data, inference QoE data, and inference MDT data. In some embodiments, each inference data of the inference QoS data, the inference QoE data, and the inference MDT data is associated with a confidence requirement. In some embodiments, the input data is received in multiple transmissions if the input data is oversized or needs to be transmitted periodically.

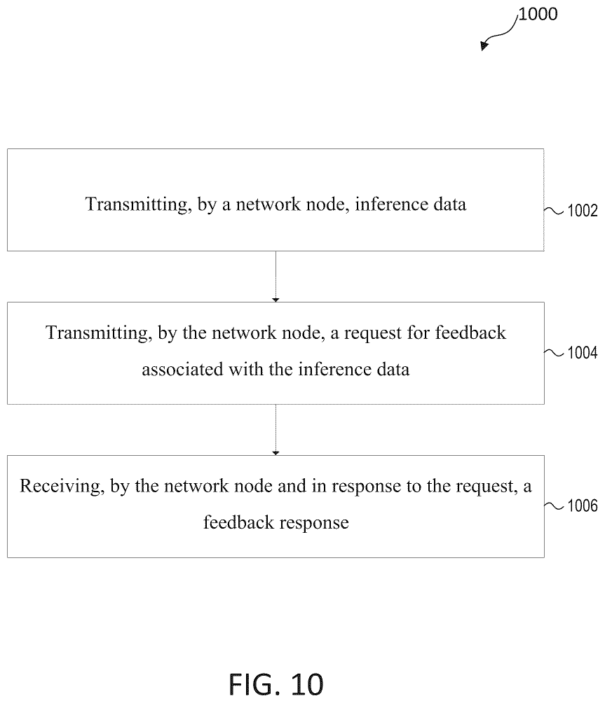

FIG. 10 is an exemplary flowchart for requesting feedback. Operation 1002 includes transmitting, by a network node, inference data. Operation 1004 includes transmitting, by the network node, a request for feedback associated with the inference data. Operation 1006 includes receiving, by the network node and in response to the request, a feedback response. In some embodiments, the method can be implemented according to Embodiment 5. In some embodiments, performing further steps of the method can be based on a better system performance than a legacy protocol.

In some embodiments, the inference data is determined by using an artificial intelligence (AI) function. In some embodiments, the request includes a request for feedback associated with a data type of the inference data, where the data type includes at least one of the following: a quality of service (QoS) type, a quality of experience (QoE) type, and a minimization of drive test (MDT) type. In some embodiments, the request includes a request for feedback associated with a relationship level between at least two of the following: quality of service (QoS) configuration, quality of experience (QoE) data, and minimization of drive test (MDT) data, where the relationship level includes at least one of the following: a numerical range, a ratio, and a list of enumerated qualities.

In some embodiments, the request includes a request for feedback associated with an accuracy level of the inference data, where the accuracy level includes at least one of the following: a numerical range, a ratio, and a list of enumerated qualities. In some embodiments, the request includes a request for feedback associated with a comparison between previous data before using the AI function and the inference data, where the comparison includes at least one of the following: a numerical range, a ratio, and a list of enumerated qualities.

In some embodiments, the feedback response includes at least one of the following: a user equipment (UE) quality of service (QoS) configuration list, a UE quality of experience (QoE) information list, a UE minimization of drive test (MDT) information list, and feedback information. In some embodiments, the feedback information includes a relationship level between at least two of the following: QoS configuration, QoE data, and MDT data, where the relationship level includes at least one of the following: a numerical range, a ratio, and a list of enumerated qualities.

In some embodiments, the feedback information includes an accuracy level of the inference data, where the accuracy level includes at least one of the following: a numerical range, a ratio, and a list of enumerated qualities. In some embodiments, the feedback information includes a comparison between previous data before using the AI function and the inference data, where the comparison includes at least one of the following: a numerical range, a ratio, and a list of enumerated qualities. In some embodiments, the feedback response is received in multiple transmissions corresponding to different timings.

In some embodiments, the network node includes one of the following: a core network (CN) node, a radio access network (RAN) node, a central unit (CU), or a distributed unit (DU), where transmitting the request and receiving the feedback response are enhanced by one of the following: a next-generation application protocol (NGAP) enhancement, an Xn application protocol (XnAP) enhancement, or an F1 application protocol (F1AP) enhancement.

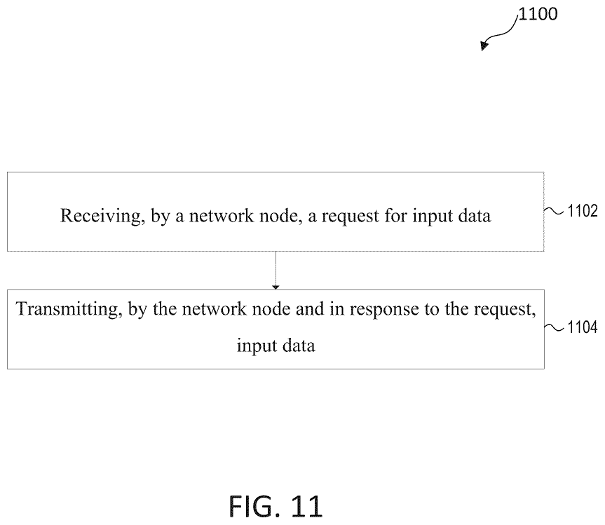

FIG. 11 is an exemplary flowchart for transmitting input data. Operation 1102 includes receiving, by a network node, a request for input data. Operation 1104 includes transmitting, by the network node and in response to the request, input data. In some embodiments, the method can be implemented according to Embodiments 1-4. In some embodiments, performing further steps of the method can be based on a better system performance than a legacy protocol.

In some embodiments, the input data is used in an artificial intelligence (AI) function. In some embodiments, the network node is a radio access network (RAN) node, where receiving the request includes receiving the request from an operations, administration, and maintenance (OAM) node or a core network (CN) node, and where transmitting the input data includes transmitting the input data to the OAM node or the CN node.

In some embodiments, the network node is a first radio access network (RAN) node, where receiving the request includes receiving the request from a second RAN node, and where transmitting the input data includes transmitting the input data to the second RAN node.

In some embodiments, the network node is a distributed unit (DU), where receiving the request includes receiving the request from a central unit (CU), and where transmitting the input data includes transmitting the input data to the CU.

In some embodiments, the network node is a central unit (CU), where receiving the request includes receiving the request from a distributed unit (DU), and where transmitting the input data includes transmitting the input data to the DU.

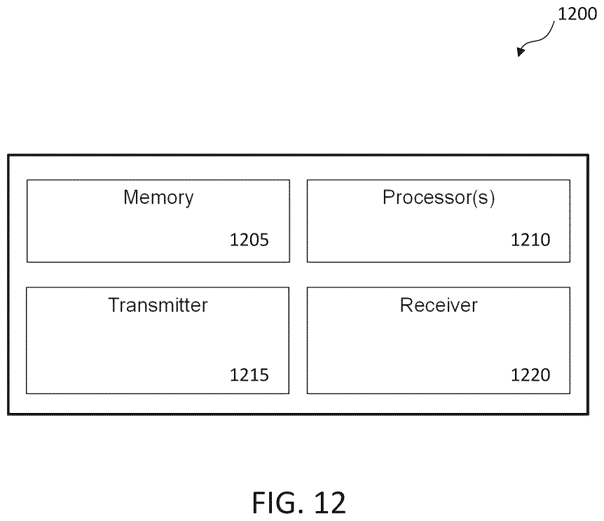

FIG. 12 shows an exemplary block diagram of a hardware platform 1200 that may be a part of a network device (e.g., base station, OAM, CN, RAN, CU, or DU) or a communication device (e.g., a user equipment (UE)). The hardware platform 1200 includes at least one processor 1210 and a memory 1205 having instructions stored thereupon. The instructions upon execution by the processor 1210 configure the hardware platform 1200 to perform the operations described in FIGS. 1 to 11 and in the various embodiments described in this patent document. The transmitter 1215 transmits or sends information or data to another device. For example, a network device transmitter can send a message to a user equipment. The receiver 1220 receives information or data transmitted or sent by another device. For example, a user equipment can receive a message from a network device. For example, a UE or a network device, as described in the present document, may be implemented using the hardware platform 1200.

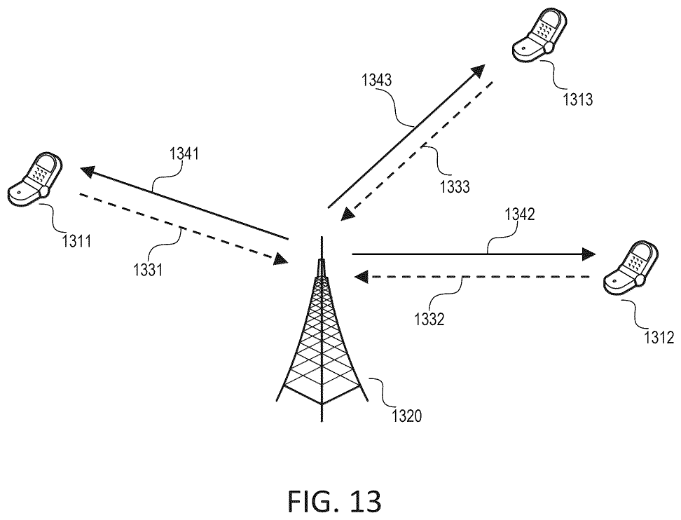

The implementations as discussed above will apply to a wireless communication. FIG. 13 shows an example of a wireless communication system (e.g., a 5G or NR cellular network) that includes a base station 1320 and one or more user equipment (UE) 1311, 1312 and 1313. In some embodiments, the UEs access the BS (e.g., the network) using a communication link to the network (sometimes called uplink direction, as depicted by dashed arrows 1331, 1332, 1333), which then enables subsequent communication (e.g., shown in the direction from the network to the UEs, sometimes called downlink direction, shown by arrows 1341, 1342, 1343) from the BS to the UEs. In some embodiments, the BS send information to the UEs (sometimes called downlink direction, as depicted by arrows 1341, 1342, 1343), which then enables subsequent communication (e.g., shown in the direction from the UEs to the BS, sometimes called uplink direction, shown by dashed arrows 1331, 1332, 1333) from the UEs to the BS. The UE may be, for example, a smartphone, a tablet, a mobile computer, a machine to machine (M2M) device, an Internet of Things (IoT) device, and so on. The UEs described in the present document may be communicatively coupled to the base station 1320 depicted in FIG. 13. The UEs can also communicate with BS for CSI communications.

It will be appreciated by one of skill in the art that the present document discloses methods to request and receive input data that can be used to train AI functions and determine AI-inferred QoS, QoE, and MDT data in wireless communications. The present document further discloses methods to request and receive feedback response associated with the AI-inferred data.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
transmitting, by a network node, a request for input data;
receiving, by the network node and in response to the request, the input data;
providing, by the network node, an updated artificial intelligence (AI) function by training an AI function using the input data; and
transmitting, by the network node, the updated AI function, wherein the request comprises at least one of the following: a processing indicator, history quality of service (QoS) configuration requirement information, history quality of experience (QoE) data requirement information, history minimization of drive test (MDT) data requirement information, inference QoS configuration requirement information, inference QoE data requirement information, and inference MDT data requirement information.

2. The method of claim 1, further comprising determining, by the network node and based on the input data, inference data using the AI function.

3. The method of claim 1, wherein the network node is an operations, administration, and maintenance (OAM) node or a core network (CN) node, wherein transmitting the request comprises transmitting the request to a radio access network (RAN) node, and wherein receiving the input data comprises receiving the input data from the RAN node.

4. The method of claim 1, wherein the network node is a first radio access network (RAN) node, wherein transmitting the request comprises transmitting the request to a second RAN node, and wherein receiving the input data comprises receiving the input data from the second RAN node.

5. The method of claim 1, wherein the network node is a central unit (CU), wherein transmitting the request comprises transmitting the request to a distributed unit (DU), and wherein receiving the input data comprises receiving the input data from the DU.

6. The method of claim 1, wherein the network node is a distributed unit (DU), wherein transmitting the request comprises transmitting the request to a central unit (CU), and wherein receiving the input data comprises receiving the input data from the CU.

7. The method of claim 1, wherein the history QoS configuration requirement information comprises at least one of the following: a history QoS configuration requirement indication, a 5G QoS identifier (5QI) reference, a QoS level identifier, a service type, a packet delay range, a maximum packet delay, a minimum packet delay, an average packet delay, a packet error rate range, a maximum packet error rate, a minimum packet error rate, an average packet error rate, a packet loss rate range, a maximum packet loss rate, a minimum packet loss rate, an average packet loss rate, a guaranteed flow bit rate range, a maximum guaranteed flow bit rate, a minimum guaranteed flow bit rate, and an average guaranteed flow bit rate, wherein the history QoS configuration requirement indication comprises a history QoS configuration requirement, and wherein a first radio access network (RAN) node, a second RAN node, a central unit (CU), or a distributed unit (DU) provides all history QoS configurations that fulfill the history QoS configuration requirement.

8. The method of claim 1, wherein the history QoE data requirement information comprises at least one of the following: a history QoE data requirement indication, a QoE level identifier, a service type, an area scope, a QoE type, radio access network (RAN) visible QoE data, a QoE report container, a codec rate, a QoE score, a QoE metric range, a maximum QoE metric, a minimum QoE metric, and an average QoE metric, wherein QoE metrics comprise at least one of the following: a round-trip time, a jitter duration, a corruption duration, a throughput, an initial playout delay for video, a video resolution, and a buffer occupancy level, wherein the history QoE data requirement indication comprises a history QoE data requirement, and wherein a first radio access network (RAN) node, a second RAN node, a central unit (CU), or a distributed unit (DU) provides all history QoE data that fulfill the history QoE data requirement.

9. The method of claim 1, wherein the history MDT data requirement information comprises at least one of the following: a history MDT data requirement indication, a downlink (DL) signal quantity measurement result, a power headroom measurement by a user equipment (UE), a received interference power measurement, a data volume measurement, an average UE throughout measurement, a packet delay measurement, a packet loss rate measurement, a received signal strength indicator (RSSI) measurement, and a round trip time (RTT) measurement, wherein the history MDT data requirement indication comprises a history MDT data requirement, and wherein a first radio access network (RAN) node, a second RAN node, a central unit (CU), or a distributed unit (DU) provides all history MDT data that fulfill the history MDT data requirement.

10. The method of claim 1, wherein the inference QoS configuration requirement information comprises at least one of the following: an inference QoS configuration requirement indication, a 5G QoS identifier (5QI) reference, a QoS level identifier, a service type, a packet delay range, a maximum packet delay, a minimum packet delay, an average packet delay, a packet error rate range, a maximum packet error rate, a minimum packet error rate, an average packet error rate, a packet loss rate range, a maximum packet loss rate, a minimum packet loss rate, an average packet loss rate, a guaranteed flow bit rate range, a maximum guaranteed flow bit rate, a minimum guaranteed flow bit rate, and an average guaranteed flow bit rate, wherein the inference QoS configuration requirement indication comprises an inference QoS configuration requirement, and wherein a first radio access network (RAN) node, a second RAN node, a central unit (CU), or a distributed unit (DU) provides all inference QoS configurations that fulfill the inference QoS configuration requirement.

11. The method of claim 1, wherein the inference QoE data requirement information comprises at least one of the following: an inference QoE data requirement indication, a start time of inference QoE data, an end time of inference QoE data, a duration of inference QoE data, a QoE level identifier, a service type, an area scope, a QoE type, radio access network (RAN) visible QoE data, a QoE report container, a codec rate, a QoE score, a QoE metric range, a maximum QoE metric, a minimum QoE metric, and an average QoE metric, and wherein QoE metrics comprise at least one of the following: a round-trip time, a jitter duration, a corruption duration, a throughput, an initial playout delay for video, a video resolution, and a buffer occupancy level, wherein the inference QoE data requirement indication comprises an inference QoE data requirement, and wherein a first radio access network (RAN) node, a second RAN node, a central unit (CU), or a distributed unit (DU) provides all inference QoE data that fulfill the inference QoE data requirement.

12. The method of claim 1, wherein the inference MDT data requirement information comprises at least one of the following: an inference MDT data requirement indication, a downlink (DL) signal quantity measurement result, a power headroom measurement by a user equipment (UE), a received interference power measurement, a data volume measurement, an average UE throughout measurement, a packet delay measurement, a packet loss rate measurement, a received signal strength indicator (RSSI) measurement, and a round trip time (RTT) measurement, wherein the inference MDT data requirement indication comprises an inference MDT data requirement, and wherein a first radio access network (RAN) node, a second RAN node, a central unit (CU), or a distributed unit (DU) provides all inference MDT data that fulfill the inference MDT data requirement.

13. The method of claim 1, wherein the input data comprises at least one of the following: history quality of service (QoS) data, history quality of experience (QoE) data, history minimization of drive test (MDT) data, inference QoS data, inference QoE data, and inference MDT data, and wherein each inference data of the inference QoS data, the inference QoE data, and the inference MDT data is associated with a confidence requirement.

14. The method of claim 1, wherein the input data is received in multiple transmissions if the input data is oversized or needs to be transmitted periodically.

15. A method of wireless communication, comprising:
receiving, by a network node, a request for input data; and
transmitting, by the network node and in response to the request, the input data,
wherein the input data is used in an artificial intelligence (AI) function, and
wherein the request comprises at least one of the following: a processing indicator, history quality of service (QoS) configuration requirement information, history quality of experience (QoE) data requirement information, history minimization of drive test (MDT) data requirement information, inference QoS configuration requirement information, inference QoE data requirement information, and inference MDT data requirement information.

16. The method of claim 15, wherein the network node is a radio access network (RAN) node, wherein receiving the request comprises receiving the request from an operations, administration, and maintenance (OAM) node or a core network (CN) node, and wherein transmitting the input data comprises transmitting the input data to the OAM node or the CN node.

17. The method of claim 15, wherein the network node is a first radio access network (RAN) node, wherein receiving the request comprises receiving the request from a second RAN node, and wherein transmitting the input data comprises transmitting the input data to the second RAN node.

18. The method of claim 15, wherein the network node is a distributed unit (DU), wherein receiving the request comprises receiving the request from a central unit (CU), and wherein transmitting the input data comprises transmitting the input data to the CU.

19. The method of claim 15, wherein the network node is a central unit (CU), wherein receiving the request comprises receiving the request from a distributed unit (DU), and wherein transmitting the input data comprises transmitting the input data to the DU.

20. An apparatus for wireless communication, comprising one or more processors, wherein the one or more processors are configured to implement a method comprising:
transmitting a request for input data;
receiving the input data in response to the request;
providing an updated artificial intelligence (AI) function by training of an AI function using the input data; and
transmitting the updated AI function,
wherein the request comprises at least one of the following: a processing indicator, history quality of service (QoS) configuration requirement information, history quality of experience (QoE) data requirement information, history minimization of drive test (MDT) data requirement information, inference QoS configuration requirement information, inference QoE data requirement information, and inference MDT data requirement information.
